(19) United States
(12) Patent Application Publication
(10) Pub. No.: US 2007/0056957 A1
(43) Pub. Date: Mar. 15, 2007

(54) Heating device and method for the production thereof and heatable object and method for the production thereof

(76) Inventors: Michael Diemer, Jonkoping (SE); Stephan Diemer, Alsheim (DE)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 10/556,992

(22) PCT Filed: May 17, 2004
(86) PCT No.: PCT/DE04/01036

§ 371 Date: Nov. 2, 2006

(30) Foreign Application Priority Data
May 16, 2003 (DE) 203076540

(51) Int. Cl. H05B 3/54

(52) U.S. Cl. 219/549

(57) ABSTRACT

The invention relates to a heating device comprising a layer containing electrically conductive plastic. The layer contains electrically conductive plastic and exhibits an adhesive characteristic at least in some sections of at least one side. The invention also relates to a method for the production of a heating device which contains a layer containing electrically conductive plastic. An adhesive is disposed at least on one side of the layer containing electrically conductive plastic. The invention further relates to a heatable object comprising an above-described heating device. The layer containing electrically conductive plastic exhibits an adhesive characteristic on at least some sections of at least one side and is connected to at least one component of the object by means of the layer containing electrically conductive plastic. An adhesive agent is produced on at least some sections on at least one side of the layer containing electrically conductive plastic and the layer with the side with the adhesive characteristic is then applied to at least the other component of the object in a method for the production of a heatable object which comprises a heating device comprising a layer containing electrically conductive plastic. The invention also relates to a flat heating element comprising a carrier and a heating layer containing electrically conductive plastic. The heating layer is formed by a flexible film and the carrier is flexible.

### FIELD OF THE INVENTION

The invention relates to a heating device, a method for the production of a heating device, a heatable object, and also a production method for such an object.

### BACKGROUND OF THE INVENTION

In numerous fields of application, electrical heaters are used to bring objects to desired temperatures. Here resistance heaters are preferred due to their good controllability and simple construction. In the meantime, it has become known to use not only conductive materials for these heaters, but also, among other things, electrically conductive plastic. The latter open up an additional wide range of shapes for corresponding heating devices, especially compared with the restrictions of typically metallic conductive materials.

From DT 26 16 771 A1, a composite heating body is known that delivers directed thermal radiation and which is formed from a plastic laminate with the inclusion of a semiconductive layer. This laminate is composed of a rigid plastic laminate structure that is formed from at least one layer of a reinforced substrate base material and a resin coating on this material, a semiconductive carbon-containing pyropolymer that is bonded to a heat-resistant inorganic oxide carrier with a large surface area that is incorporated as a layer on at least one side of the layer of the substrate material, a heat-reflective layer incorporated in a position on one side of the pyropolymer on the substrate material, and current feeding devices into parts of the layer made from conductive carbon-containing pyropolymer spaced apart from each other and generates electrical resistance heating in the laminate, which is reflected and emitted by the heat-reflective layer of the composite body. Such heating plates are to be used as part of a living-room or office wall.

In this state of the art, the semiconductive layer can be incorporated in the laminate, such that a finely divided carbon-containing pyropolymer is mixed in the form of small particles or as powder with a suitable carrier or vehicle, such that it is laid on, spread, or in some other way deposited on the surface of a resin-coated glass cloth, paper, felt, cardboard, and the like as a laminate substrate or one a wood veneer, which is used in the laminate plate. Instead, the finely divided carbon-containing pyropolymer can also be mixed with the resin or polymer material, with which a special reinforcing base material is to be impregnated or which is to be deposited on this base material as a coating, wherein this base material supplies at least one substrate material layer of the laminate. The resulting mixture is deposited in or on the substrate through immersion or coating, and the resulting coated substrate is subjected to semicured, such that the semiconductive pyropolymer leads to a uniform impregnation and coating over the resulting semicured laminate sheet.

DE 33 16 182 A1 concerns the use of molded bodies, such as films, plates, or three-dimensionally shaped structures, from the class of polymerized pyrrole, which are complexed with anions, as electrical heating elements particularly for heating corrosive fluids or gases. Here, the molded bodies can still be coated with organic plastics.

A polymer compound heating element is described in DE 35 24 631 A1 and has the form of a film, tube, or bar. Such polymer compound heating elements can be used as such as heat sources or can be laminated with conventional plastic films, in order to improve the material thickness.

The use of electrically conductive thermoplastic polyurethane, as well as its production, is known from DE 33 21 516 A1. Corresponding products are suitable, among other things, for the production of 1 to 2 mm thick films for flat heating elements.

Thus, in principle, heating devices with electrically conductive plastic are known, but the entire state of the art contains no information or suggestions on how such heating devices must be equipped and produced in order to be able to be used in practice.

### SUMMARY OF THE INVENTION

Therefore, one goal of the present invention is to create a heating device with an electrically conductive plastic with lowest possible expense and also to create an object with this heating device.

This goal is achieved with a heating device, a method for the production of a heating device, a heatable object, and also to a production method for such an object as set forth in the claims. Other preferred and advantageous configurations of the invention are also set forth in the claims and their combinations.

Thus, according to the invention, a heating device with a layer with electrically conductive plastic is created, wherein the layer with electrically conductive plastic has all adhesive characteristic at least in some sections of at least one side.

Preferably, the layer with electrically conductive plastic has an adhesive at least in some sections of at least one side for providing the adhesive characteristic. In a preferred improvement, the layer with electrically conductive plastic has an adhesive at least in some sections on both sides.

Preferably, the adhesive is a bonding agent and, in particular, the layer is an adhesive tape.

As an alternative to the preceding improvements of the invention, the layer can be an adhesive layer, wherein the adhesive layer is preferably a bonding-agent layer. Such a bonding-agent layer can be composed of a layer of bonding cement containing the carbon or carbon particles, in order to provide electrical conductivity.

According to another variant of the invention that can be used advantageously, the layer with electrically conductive plastic and, if necessary, the adhesive, is/are transparent at least to a large degree or in some sections. A heating device according to the invention embodied in this way can also be used advantageously for disks and the like.

Furthermore, it is advantageous and there preferred when the adhesive can be cured. According to one improvement, it can be provided, in particular, that the cured adhesive remains cured at least to a large degree when the temperature increases.

In another extension of the invention, the electrically conductive plastic contains polyurethane.

In the scope of the invention, a method for the production of a heating device is also created, which contains a layer with electrically conductive plastic, wherein an adhesive is deposited at least on one side of the layer with electrically conductive plastic.

This method is preferably improved in that an adhesive is deposited on both sides of the layer with electrically conductive plastic.

To allow an especially simple use of a heating device produced according to the invention, the heating device can be produced in sheets or as strip material. According to one improvement, a desired shape of the heating device is cut or stamped from sheets or strip material before the heating device is bonded to the object my means of its adhesive.

For the further processing and use of the heating device according to the invention, it is advantageous when it is further provided for its production method that the adhesive is covered with a removable protective layer after applying the electrically conductive plastic onto the layer.

In an alternative method for the production of a heating device which contains a layer of electrically conductive plastic, it is provided according to the invention that an adhesive is mixed with an electrically conductive plastic and that the adhesive mixed with the electrically conductive plastic is deposited as a layer onto a surface.

Furthermore, a heatable object with a heating device is created by the invention, as was disclosed above as lying in the scope of the invention, wherein the layer with electrically conductive plastic has an adhesive characteristic at least in some sections on one side, by means of which the layer with electrically conductive plastic is bonded to at least one component of the object.

In an alternative heatable object with a heating device according to the invention, the layer with electrically conductive plastic has an adhesive characteristic at least in some sections on both sides and are bonded to other components of the object by means of the adhesive characteristic of the heating device.

Both variants disclosed above for heatable objects according to the invention can be improved in that the layer with electrically conductive plastic by means of the adhesive characteristic is present only in one section of the other component or of the other components of the object. Alternatively, in the embodiments, the layer with electrically conductive plastic can be present at least to a large degree over an entire surface of the other component of the object.

Furthermore, a method for the production of a heatable object is created by the invention, which contains a heating device with a layer with electrically conductive plastic, wherein an adhesive characteristic is produced in the layer with electrically conductive plastic at least in some sections at least on one side, and that the layer is then applied to at least one other component of the object with its side with the adhesive characteristic.

Furthermore, in the previously described method, it can also be provided that an adhesive characteristic is produced in the layer with electrically conductive plastic at least in some sections on both sides and that the layer is then applied to another component of the object with each of its sides with the adhesive characteristic, in order to bond the two different components. Furthermore, in this way or as an alternative, the adhesive characteristic can be produced over the entire area of the layer with electrically conductive plastic.

Preferably, the applicable adhesive characteristic is produced in the layer with electrically conductive plastic by applying adhesive on the corresponding side of the layer with electrically conductive plastic.

In another solution according to the invention for a method for producing a heatable object containing a heating device with a layer with electrically conductive plastic, at first an adhesive is mixed with an electrically conductive plastic, then the adhesive mixed with the electrically conductive plastic is deposited on a first component of the object, and then the first component is bonded to a second component of the object by means of the adhesive with the added electrically conductive plastic.

Furthermore, preferably the adhesive is cured after the final contact with the corresponding other component of the object.

As additional advantages, the invention permits a good, simple, and operationally safe construction as well as good heat distribution.

According to the invention, a flat heating system with a carrier and a heating layer is created, which contains electrically conductive plastic, wherein the heating layer is formed by a flexible film and the carrier is flexible.

Such a flat heating system is refined in the scope of the present invention such that the carrier is a layer, especially a woven or nonwoven fabric, preferably a natural or synthetic fibrous nonwoven fabric. Alternatively, the carrier can be a molded part made from an elastic material, for example, a seat cushion for a sitting surface or a backrest or a mattress.

Preferably, the heating layer contains polyurethane, single-component polyurethane, cross-linked single-component polyurethane, a PU foam, UV-resistant and/or hydrolyzable or vapor-permeable plastic material. However, other electrically conductive or conductive and foaming materials can be used, wherein plastic materials are preferred. Alternatively or additionally, it is preferred that the electrically conductive plastic of the heating layer contains graphite, preferably in powder form.

For the flat heating system, it can be further provided that contact ends of power supply wires in the heating layer or between the carrier and the heating layer are in contact with the heating layer. Preferably, the contact ends of the power supply wires are fixed to the heating layer by means of the heating layer itself or are stitched or adhered to the heating layer and/or to the carrier.

Furthermore, it is advantageous that the heating layer is formed directly on the carrier through spraying, rolling, or coating. Alternatively, the heating layer can be adhered, stitched, or welded or in some other way fastened to the carrier.

Advantageously, a manual and/or electrically/electronically activated and/or automatic current control is provided, which can be connected to a power source and which is connected to the power supply line wires, whose contact ends are in contact with the heating layer.

In addition, a heatable object which contains a flat heating system according to the configurations above is created by the invention.

In the scope of a preferred configuration, the object is a sitting surface or a backrest or a cushion for sitting or sleeping furniture, especially a mattress, and the heating layer is adapted to the anatomy of the upper leg-sitting surfaces or back surfaces of a user. The latter is advantageously achieved in that the heating layer is shaped anatomically in the plane of the sitting surface or the backrest or the cushion of sitting or sleeping furniture, especially a mattress, in that it is present or electrically conductive only according to anatomical conditions. Alternatively or additionally, the heating layer can have a corresponding thickness profile for anatomically adapted heat discharge.

Another preferred configuration of the heatable object consists in a cushioned lining, especially in a vehicle. Such a heatable object can be designed for heat discharge that varies over its surface area.

In general, it can be further provided that the heating layer is profiled in its surface-area distribution and/or in its thickness for heat discharge that varies over its surface area.

Finally, the present invention also creates a method for producing a flat heating system, wherein a heating layer with electrically conductive plastic is bonded to a carrier. According to the invention, the heating layer is formed first by applying an electrically conductive, especially foaming or foam-plastic material onto the carrier, and then curing the plastic material on the carrier. A preferred improvement of this method consists in that before the application of the electrically conductive, especially foaming or foam-plastic material onto the carrier, contact ends of the power supply wires are first arranged on the side of the carrier, on which the plastic material is then deposited.

Alternatively, in a method according to the invention for the production of a flat heating system, wherein a heating layer with electrically conductive plastic is bonded to a carrier, it is provided that the heating layer is produced from an electrically conductive, especially foaming or foam-plastic material, and then arranged on the carrier. Here, preferably the heating layer can be bonded to the carrier in a slip-proof way after being arranged on the carrier. This is realized preferably in that the heating layer is stitched, adhered, or welded to the carrier.

Advantageously, but without restriction, electrically conductive polyurethane is used as the plastic material.

The method can be improved in that contact ends of power supply wires are attached to the heating layer and/or to the carrier, so that they are in contact with the heating layer in the adhesion of the carrier and heating layer. For this purpose, the contact ends of power supply wires are preferably stitched or adhered to the heating layer and/or the carrier.

Another extension of the method according to the invention consists in that the heating layer is profiled in surface area shape and/or thickness during or after its production. This can be realized during the production of the heating layer directly on the carrier, for example, by means of templates, which define the surface area shape of the heating layer. If the heating layer is produced separately, i.e., not directly on the carrier, then its shape can be obtained, for example, through shaping frames or also stamping. Also, the thickness can be varied over the surface of the heating layer.

Preferred and advantageous improvements emerge from the dependent claims and their combinations, as well as the entire contents of disclosure of this document under the inclusion of expert knowledge and the state of the art, especially as indicated in the introduction of this description.

For example, the electrically conductive plastic material of the heating layer can contain carbon or carbon particles in order to provide electrical conductivity. Incidentally, the material of the heating layer is such that it is at least to a large degree cured due to a heating effect during or after an increase in temperature and also remains, incidentally, dimensionally stable and undamaged. Polyurethane (PU) is preferably used, as already mentioned, for the electrically conductive plastic, but in principle all of other materials disclosed in the state of the art named above can also be used, if it allows foaming. Additional material details and technical background are disclosed, for example, in the publications DE G 85 23 328.5, DE 298 08 842 U1, DE 197 11 522 A1, and DE 691 01 703 T2, whose contents are herewith incorporated into the present document to their full extent through this reference for avoiding simple repetition.

### BRIEF DESCRIPTION OF THE DRAWINGS

The invention is explained in more detail below with reference to embodiments, which are shown in the drawings, in which

FIG. 1 shows schematically, in a perspective view, a first embodiment of an object with a heating device in the form of a motor vehicle external mirror,

FIG. 2 is a schematic representation of an object analogous to FIG. 1 with a heating device in the form of a motor vehicle external mirror according to the state of the art in a perspective view,

FIGS. 3a, 3b, and 3c illustrate a second and a third embodiment of an object with a heating device schematically in a perspective overview representation and a section view, respectively, in the form of different internal linings in a motor vehicle,

FIGS. 4a and 4b show schematically an inner lining and a windshield for a motor vehicle as fourth and fifth embodiments of objects with a heating device in a perspective overview representation and a section view, respectively,

FIGS. 5a and 5b show schematically a sixth embodiment of an object with a heating device in a perspective overview representation and a section view, respectively, in the form of a floor covering for a motor vehicle, and

FIGS. 6a and 6b illustrate, in the scope of a sixth embodiment, the application of the invention in an airplane wing schematically in a perspective overview representation and a section view, respectively.

In the following description of the invention with reference to embodiments, the same reference symbols are used consistently for identical or equivalent parts. Even if all of the details of the graphical representations are not discussed in the following description, the individual features and their relationships emerge from the figures themselves, as long as they are illustrated in the figures, for someone skilled in the art without additional description.

As a first embodiment of a heatable object 1 with a beating device 2, in FIG. 1 a heatable external mirror 3 of a motor vehicle (not shown) is shown. The external mirror 3 contains a mirror plate 4 and also a plastic cover 5 as a carrier. In between there is a layer 6, which contains electrically conductive plastic, e.g., polyurethane, and thus represents a heating device 2, which can be operated electrically. Furthermore, the layer 6 has an adhesive characteristic on both sides 7 and 8. For this purpose, the two sides 7 and 8 are each provided with adhesive 9, which is formed in the shown example by a bonding agent. Therefore, the layer 6 can also be considered a double-sided adhesive layer, which simultaneously provides electrical conductivity, so that they can be heated electrically. The layer 6, which is shown in FIG. 1, can be, for example, a double-sided adhesive film. Furthermore, FIG. 1 shows schematically electrical connections in the form of conductor ends 10 and 11 to the layer 6, by means of which the latter is connected, preferably in a controllable way, to a power source (not shown). The electrical connections 10 and 11 can each be inserted therein or attached thereon according to the thickness of the layer 6.

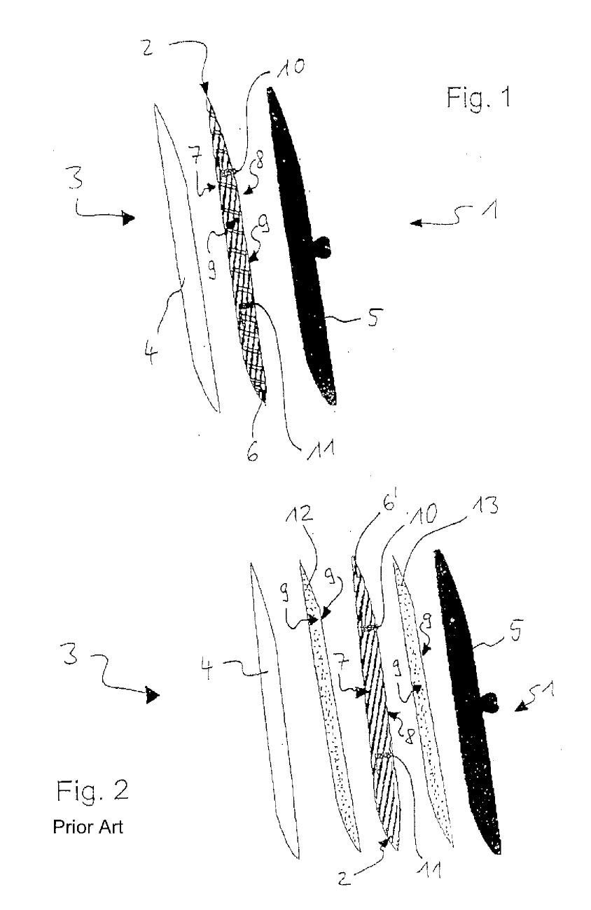

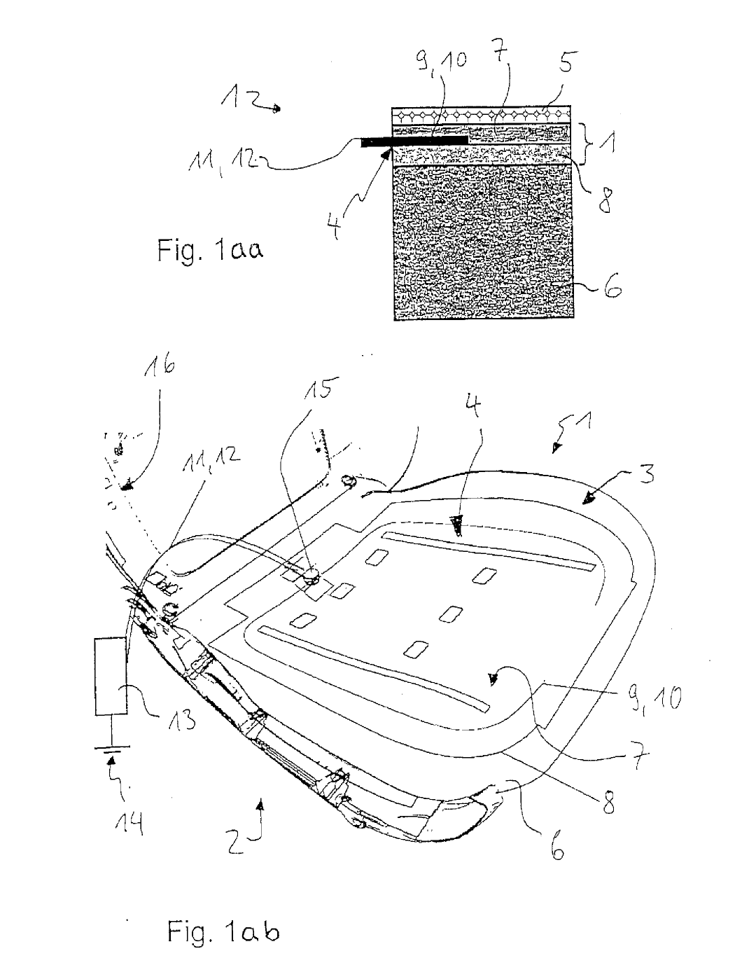

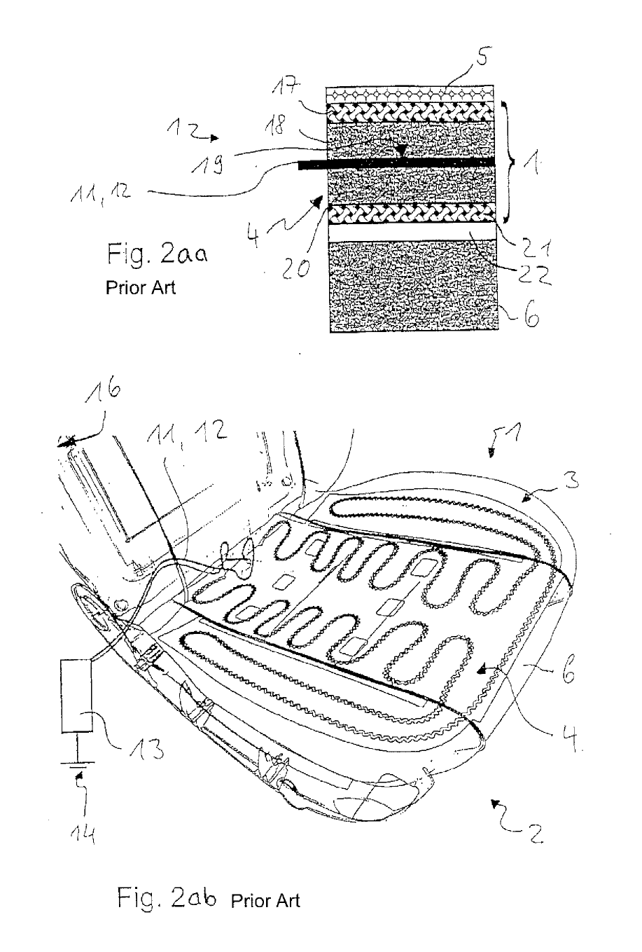

The advantage of the first embodiment of the invention according to FIG. 1 becomes clear, especially in the comparison with the construction according to the state of the art, which is shown analogously in FIG. 2.

As is visible in FIG. 2, in a heatable external mirror 3 for a motor vehicle according to the state of the art, in addition to the mirror plate 4 and the plastic cover 5, as well as the layer 6′ with electrically conductive plastic lying in-between, there are also double-sided adhesive layers 12 and 13, by means of which, on one side, the mirror plate 4 is connected to the layer 6′ with electrically conductive plastic and, on the other side, the latter is connected to the plastic cover 5. In practice, the electrical heating layer 6′ of the state of the art is provided on both sides with the double-sided adhesive layers 12 and 13 before the assembly between the mirror plate 4 and the plastic cover 5.

The two adhesive layers 12 and 13 are not required in an external mirror 3 according to the invention. However, the invention not only eliminates the two adhesive layers 12 and 13, but also reduces the assembly costs for such an external mirror 3, because the two adhesive layers 12 and 13 do not have to be attached to the layer 6′, which leads to further savings. The advantage in the embodiment according to FIG. 1 lies in that, in the especially skillful double use of the layer 6, first as a heating layer, because it contains the electrically conductive plastic, and second as a double-sided adhesive layer, which connects the mirror plate 4 and the plastic cover 5.

The scope of the invention also includes when, in the embodiment of FIG. 1, the plastic cover 5 itself contains the electrically conductive plastic and is provided on its surface facing the mirror plate 4 with the adhesive characteristic, in that an adhesive 9, in particular, a bonding agent, is deposited at this position. In this variant, the plastic cover 5 itself functions as a heatable and adhesive layer. Thus, a separate double-sided adhesive layer can be eliminated, which leads to corresponding savings in the assembly. Because only one layer of adhesive is necessary, in comparison with two layers in the example according to FIG. 1, additional adhesive material is saved.

In another alternative of the embodiment of FIG. 1, the layer 6 itself is composed of only one adhesive, which contains electrically conductive plastic and which is deposited during the assembly of the external mirror 3 directly on the plastic cover 5 or the mirror plate 4. This configuration enables the use of previously typical plastic covers 5 and mirror plates 4, which can be produced without additional means, without changes in the simultaneous savings in the production and assembly of the double-sided adhesive layer. Also, a double-sided adhesive layer with adhesive characteristic does not have to be changed in shape, which makes the production process of the external mirror 3 more economical.

The adhesive used in the preceding embodiments as an adhesive 9 has properties such that it cures after the connection of the parts between which it is deposited. So that the connection produced in this way is as durable as possible, it is advantageous when the adhesive does not soften again when the layer 6 is heated. To the extent that the latter feature is absolutely necessary depends on the properties and requirements set on the heatable object 1 or at least its heating device 2 in the actual realization.

When, as is often typical, individual mounting components, e.g., of the previously described external mirror 3 are supplied from third-party suppliers, it can be advantageous when the optionally prefabricated layer 6 is provided at first on its side(s) provided with adhesive with a protective layer/layers (not shown). In this way, for example, also the shape of the layer 6 can be produced according to requirements from uniform strip or sheet material, e.g., through stamping or cutting. In other configurations, however, the layer 6 can also be fed wound on rollers to the production process of the object 1, wherein then either the shape and dimensions of the strip material are held within the dimensions of the object to be provided with this material or are cut after joining the strip material with at least one component, e.g., of the plastic cover 5. If the layer 6 is first formed during the production of the object 1, then shaping measures for the layer 6 can be eliminated, in that corresponding adhesive 9 is easily applied to a surface of a component, for example, the mirror plate 4, of the object 1, so that in especially simple means and measures, a surface-covering coating of the layer 6 is achieved on the corresponding component of the object 1.

In each of the previously described variants, the electrical contacts or connections can be attached before, during, or after the connection of the layer 6 with another component of the object 1 in the layer 6 or between the layer 6 and the other component of the object 1, i.e., in particular, without requiring a separate processing step. For attaching the electrical connections to the layer with electrically conductive plastic, suitable devices, which allow winding, soldering, placement, insertion, clamping, etc., of electrical lines, can also be provided on the layer itself.

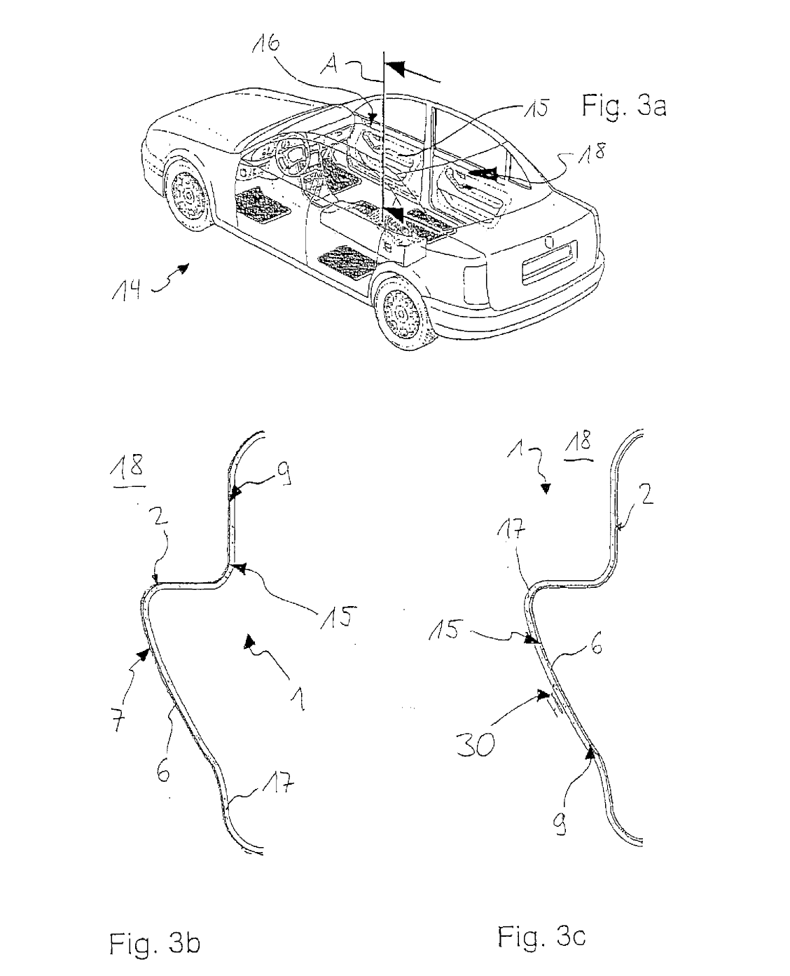

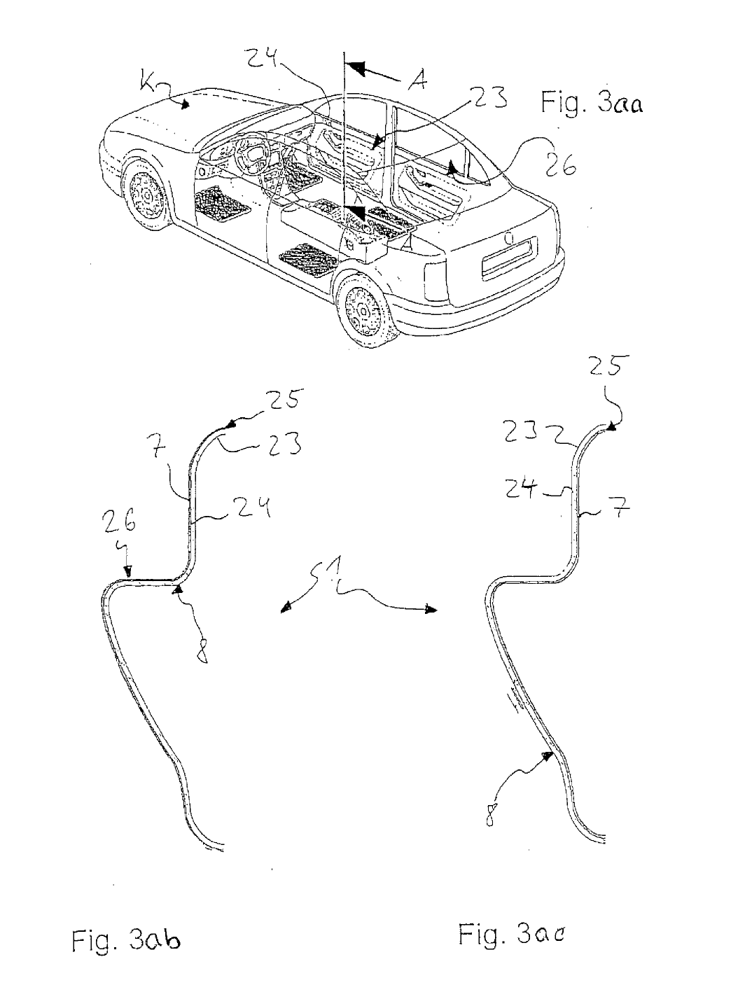

In FIGS. 3a, 5b, and 3c, 4a and 3b, as well as 5a and 5b, additional embodiments of heating devices in motor vehicles are shown.

In FIG. 3a, a motor vehicle 14 is shown in a cut-away view, in which a section plane A is shown schematically through an inner lining 15 of a vehicle door 16. The schematic section view of the inner lining 15 is the section plane A according to the arrows shown in FIG. 3a is shown as a second embodiment of a heatable object 1 with a heating device 2 in FIG. 3b. This inner lining contains a carrier layer 17, on which the layer 6 with electrically conductive plastic is attached by means of adhesive 9. Because the visible surface of the inner lining 15 is formed by the layer 6 with electrically conductive plastic, the free, visible side 7 of the layer 6 with electrically conductive plastic can be provided with decoration (not visible), e.g., an artificial leather-like appearance, in order to realize a pleasant exterior for the inner lining 15.

As an alternative to the previously described embodiment, in one variant that is shown in FIG. 3c in a section view, the layer 6 with electrically conductive plastic can be applied by means of adhesive 9 onto the side of the carrier layer 17 facing away from the interior space 18 of the motor vehicle 14. In such a case, either the carrier layer 17 itself can be provided with decoration (not visible) on its visible side, or decoration 30 (which is only partially indicated for better clarity) can be applied to the visible side of the carrier layer 17.

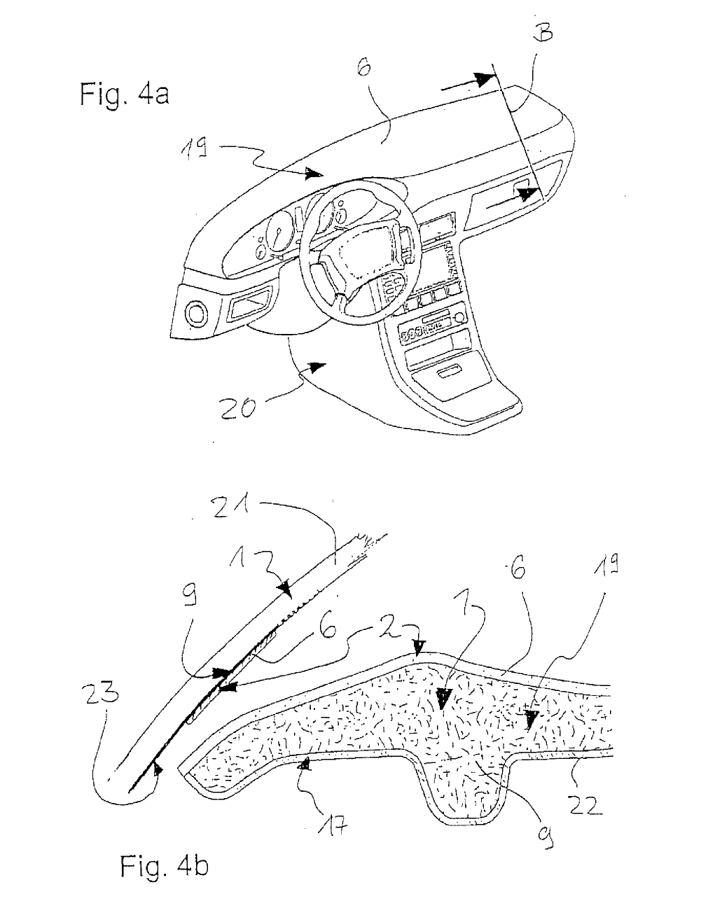

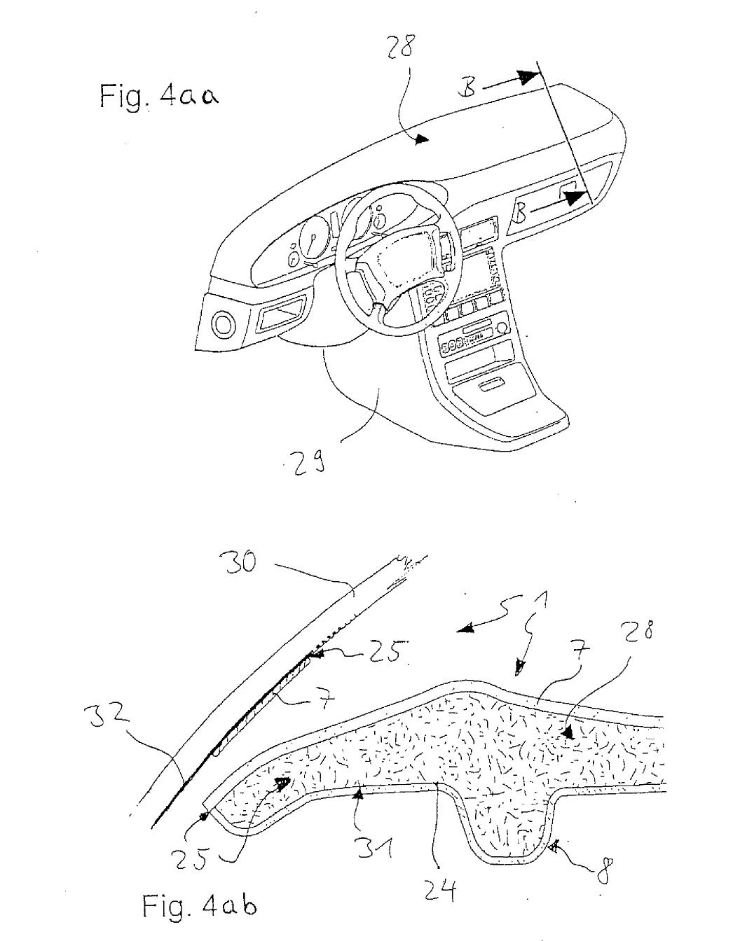

The principle of the two embodiments described above can be transferred to the entire passenger compartment 18 of the motor vehicle 14. For example, for realizing or assisting a seat heating system, a shaped roof lining, a rear-seat shelf, column linings, consoles, a steering wheel, carpet material, air ducts, especially on the inside for preferably preheating cold air, among many other things, can be used as heatable objects with heating devices, which contain a layer 6 with electrically conductive plastic, for improving the air conditioning in a motor vehicle. Therefore, it is not only possible to design conventional heating systems to be smaller, but also a faster and more uniformly distributed or targeted heating of the entire interior 18 of a motor vehicle 14 can be achieved. Additional actual embodiments are illustrated in FIGS. 4a and 4b, as well as 5a and 5b.

FIG. 4a shows, in a perspective view of a dashboard 19 and a console 20, the position of a section plane B, wherein the direction of view on the section plane according to the representation in FIG. 4b is illustrated by arrows. FIG. 4b is the section view through the dashboard 19 in the section plane B, wherein a part of an adjacent windshield 21 of the correspondingly equipped motor vehicle 14 is shown in section. The layer 6 with electrically conductive plastic forms the plastic skin, with which the dashboard 19 is coated and which forms the surface of the latter. By means of an adhesive 9, which is formed in the present fourth embodiment by a tiller, such as a foaming agent, etc., the layer 6 with electrically conductive plastic is connected to a carrier layer 17 used as a holder 22. The layer 6 with electrically conductive plastic here forms a molded skin with embedded conductive material. Alternatively, in this embodiment, somewhat analogously to the variant shown i FIG. 3c, the layer 6 with electrically conductive plastic could also be coated with a decorative layer (not shown).

In FIG. 4b, as another embodiment of a heatable object 1, a windshield 21 is shown partially in section. This windshield 21 is provided in the area of its periphery with a black ceramic layer 23, which can be applied, for example, through screen printing. It is further provided that in the area of the ceramic layer 23, a layer 6 with electrically conductive plastic is attached directly or by means of an adhesive 9, for example, a bonding agent, to the windshield 21. Through this configuration, e.g., a surrounding, additional, and/or separate heating system of the windshield 21 can be realized for preventing and removing condensation or for de-icing. In addition, such a heating device 2 can be provided, in particular, in the area of the rest position of windshield wiper blades (not shown), in order to realize here an additional and/or separate heating of the windshield 21, so that damage to frozen windshield wiper blades (not shown) can be prevented when the wipers (not shown) are activated.

If the layer 6 with electrically conductive plastic is composed of transparent material, then a transparent area of a window, e.g., a windshield 21, can also be provided with a corresponding heating device 2. Therefore, condensation can also be removed or prevented on windows equipped in this way and the window can also be defrosted. The heating wires used up until now, for example, in rear windshields (not shown), could then be eliminated or made with smaller dimensions.

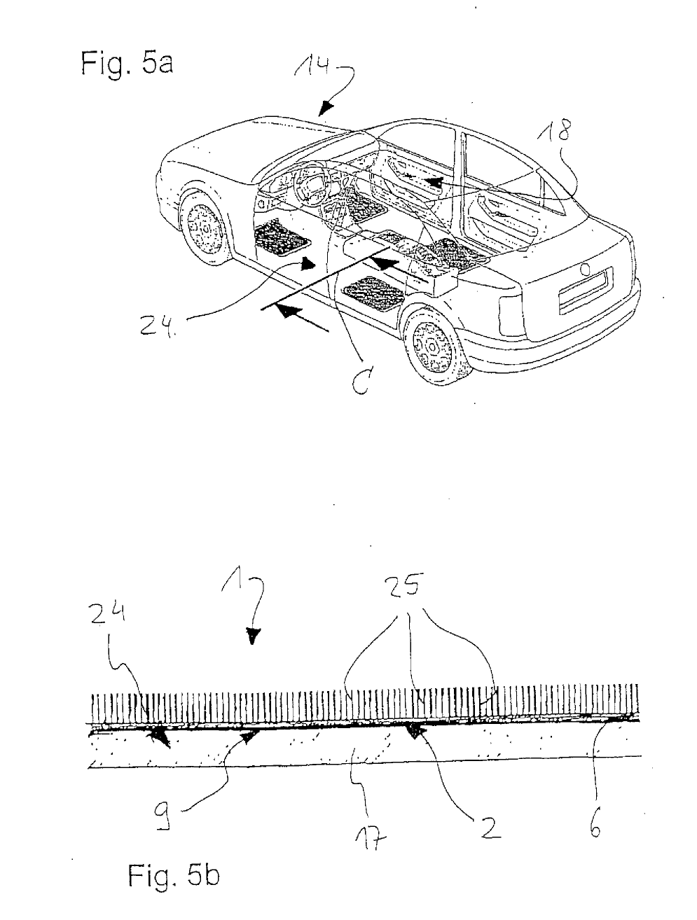

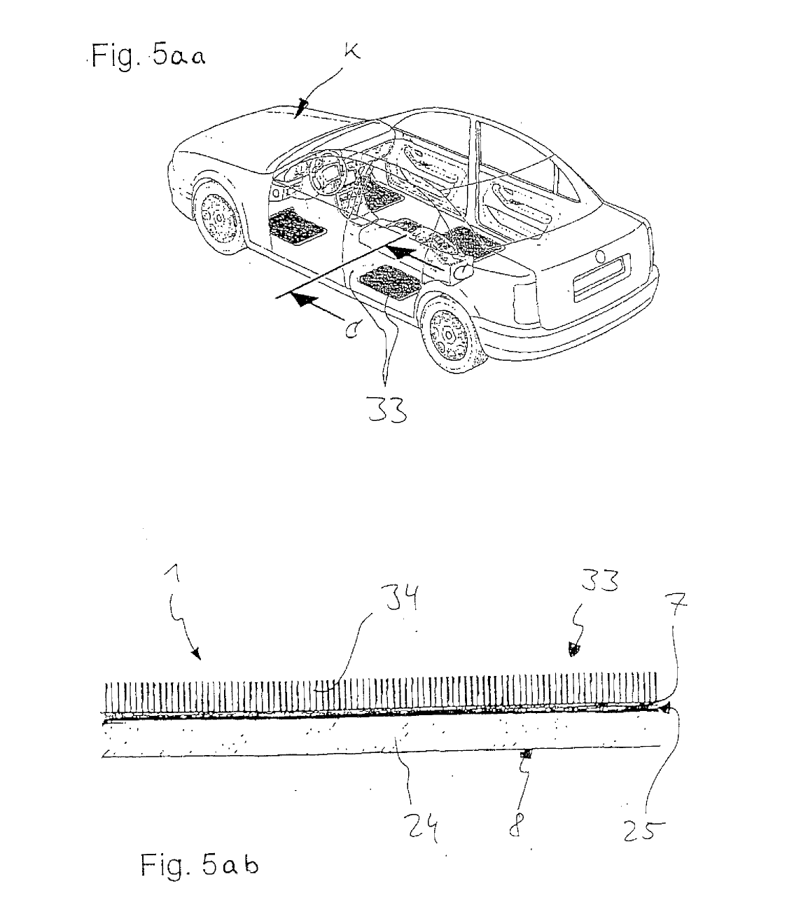

As another variant for interior heating of a motor vehicle 14, in FIGS. 5a and 5b, the configuration of carpet material 24 as heatable objects 1 is shown. In this sixth embodiment, which is shown in FIG. 5b in a partial section view, which is to be seen according to the arrow direction on a section plane C in the view of FIG. 5a, the construction of such a carpet material 24 is shown. Here, the layer 6 with electrically conductive plastic is bonded to a bottom carrier layer 17 by means of the adhesive 9.

The bristles, loops, or general fibers/threads 25, which form the top side of the carpet material 24, can be fixed either to the carrier layer 17 and can penetrate through the layer 6 with electrically conductive plastic, but can be applied directly only to the layer with electrically conductive plastic, or they can start from a separate position (not shown), which is bonded to the layer 6 with electrically conductive plastic by means of adhesive 9. In the latter case, the carrier layer 17 can also be eliminated.

The scope of the present invention also includes when the layer 6 with electrically conductive plastic is formed directly by the carrier layer 17, or when the layer 6 with electrically conductive plastic is fixed to the carrier layer 17 by means of bristles, loops, fibers, or threads 25, which form the top side of the carpet material 24. Furthermore, it is possible to apply the layer 6 with electrically conductive plastic under the use of an adhesive 9 to the bottom side of the carrier layer 17, so that conventional carpet material 24 is further produced in a conventional way and can be provided later with the heating device 2. It is further possible to retrofit already existing carpet material 24 with a heating device 2 accordingly.

As already mentioned, it is possible by connecting the layer 6 with electrically conductive plastic material to a power source (not shown), in order to achieve a desired heating or warming effect for the correspondingly heated objects. Because the electrical resistance of the layer 6 is constant, by means of the supplied electrical power the heating temperature can be defined or regulated. Advantageously, there is the ability to use both direct current and also alternating current, in particular, without generating electromagnetic pollution. Because the heat generated in this way involves flat heat exclusively, a certain temperature and heating comfort is realized.

For the use of natural raw materials, e.g., wood fibers, sisal, material from banana trees, cocoa fibers, etc., the generation of odor during humid weather, as well as bacterial contaminations, often represent large problems. As in the previously described embodiments, when inner lining parts are designed to be heatable, in combination with the pure heating effect, the prevention of such odors and bacterial contaminations can also be achieved.

Other actual examples for heatable objects 1 with heating devices 2 according to the present invention include, for example, a diesel tank made from plastic, with which paraffin crystallization in diesel fuel can be prevented at low outside temperatures by maintaining a minimum temperature; an oil sump, which, when heated, can preheat the motor oil for better and more efficient operation of the engine; an entire engine compartment, which allows preheating of the engine; as well as, for example, also storage areas both in passenger cars and also trucks. Thus, heating devices 2 can be used advantageously in the interior and exterior area of motor vehicles.

However, the present invention is not limited to use in the field of motor vehicles. All of the embodiments and variants named above, as well as analogous applications, can also be applied to other vehicles with two wheels, such as trains, ships, and airplanes.

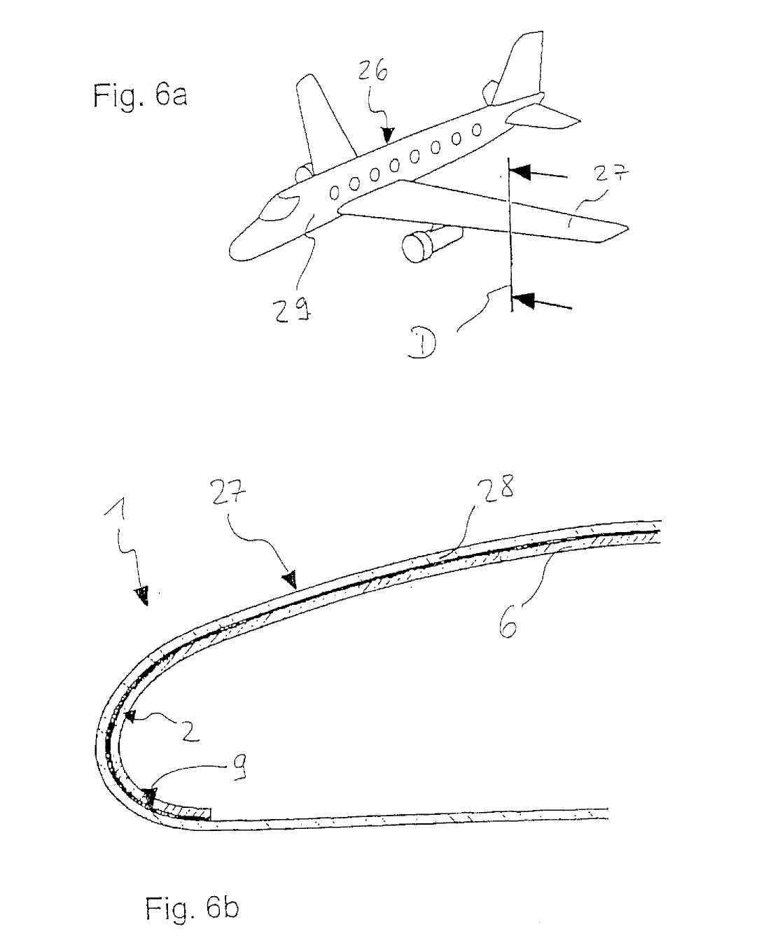

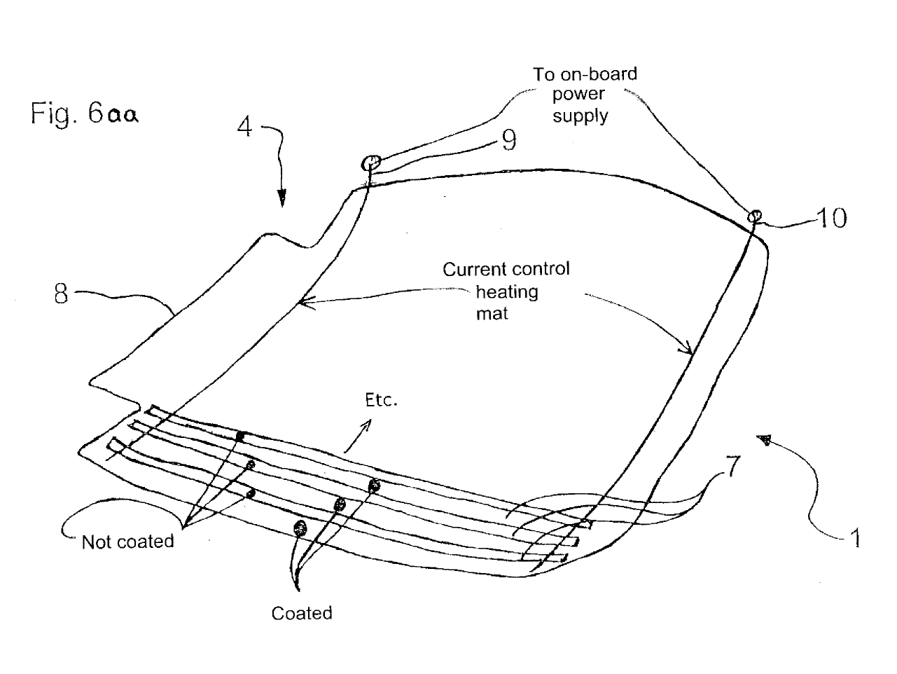

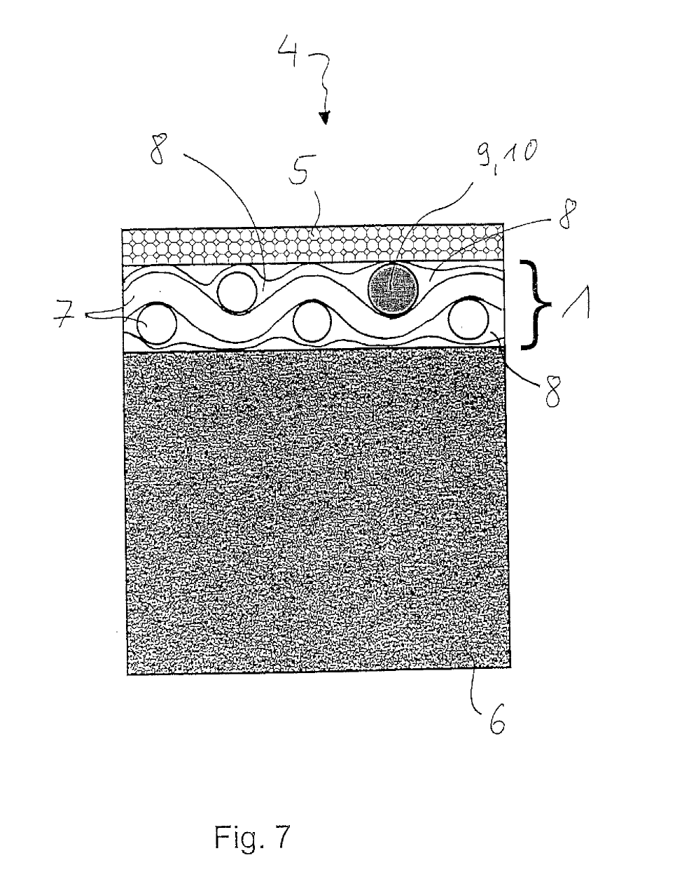

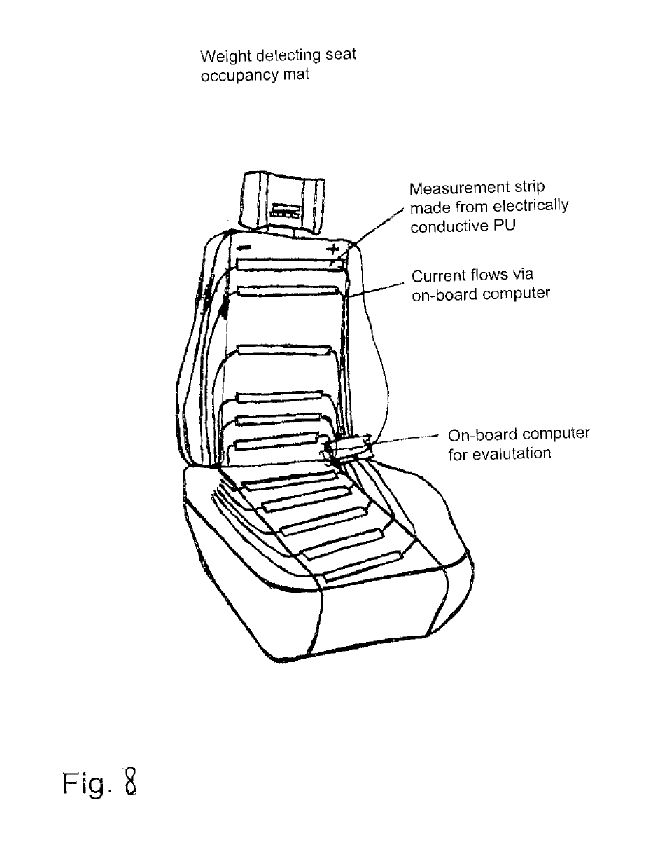

An example is shown in FIGS. 6a and 6b. FIG. 6a is used for illustrating a section plane D in the area of a wing 27 of an airplane 26, wherein the direction of view of the section view of FIG. 6b is again illustrated by arrows. The section view itself of a part of the airplane wing 27 is shown in FIG. 6b. The airplane wing or the airfoil 27 has an exterior skin 28, on whose inner side a layer 6 with electrically conductive material is applied. The attachment of the layer 6 with electrically conductive material to the exterior skin 28 of the wing 27 is realized through adhesive 9. The electrically conductive layer 6 allows heating of the wing 27 from the inside, so that the wing cannot ice over. In addition to the wings 27, the fuselage 29 of the airplane 26 (see FIG. 6a) can also be heated in a similar way and thus protected from icing. For propeller airplanes (not shown), for example, through the use of a heating device 2 according to the invention on the propeller (not shown), an expensive electronic heating system (not shown) acting against icing can be replaced. In particular, in the airplane field, but also in other applications of the present invention, additional de-icing fluids can be avoided or at least greatly reduced by the present invention, which can penetrate into the ground or the air, so that the present invention also contributes to the protection of the environment.

As already mentioned, numerous other fields of application of the present invention are also possible, e.g., for motorcycles and mopeds and the like, seats and control elements can be equipped with corresponding heating devices. Other possible applications exist, for example, in the household (coating plastic wallpaper, wood decks, wood floors, carpets, tiles, covers for heating and water pipes, floor heating systems), in clothing and the like (shoes, boots, ski boots, work clothing, protective clothing, gloves, electric heating and warming blankets, for example in the hospital field, heating packs), in sports and hobbies (artificial grass playing fields, tent floors, sleeping surfaces in tents), as well as in the military (among other things, for preheating vehicles for better engine start-up in the winter).

Here, as preferred plastic materials that are electrically conductive or that can be made electrically conductive, only aliphatic or aromatic polyurethanes are named, in particular.

In terms of the production of a heating device according to the invention or of an object with this device, it is preferred when the layer with or made from electrically conductive plastic is produced in a spraying or immersion method or through roller application. A corresponding coating is provided preferably in a method for producing a heating device or an object with this device. In this way, the invention allows, in particular, also an adaptation or selection of the coating method in terms of the geometry of the shape to be coated and/or of the quantity to be produced.

In the configurations discussed above as examples and for comparison, the layer thickness of the electrically conductive layer is preferably between approximately 0.05 mm and approximately 0.3 mm. If the electrically conductive layer is also to fulfill a function as a visible surface, then it is preferred when the thickness is greater. In particular, the scope of the present invention also includes adapting the layer thickness as a function of the requirements or required profile for the heating device(s) or for the object(s), which can be easily discovered through calculations or tests. For example, a layer thickness of 1.2 mm is provided when it involves a surface layer with an additional function, e.g., a vehicle inner lining.

The invention is described below in more detail with reference to the other figures of the drawing in terms of possible constructions.

FIGS. 1aa and 1ab show schematically in a partial section and perspective view, respectively, a first embodiment of the invention in connection with a motor vehicle seat with a seat heating system.

FIGS. 2aa and ab show schematically in a partial section and perspective view, respectively, a motor vehicle seat with a seat heating system according to the state of the art.

FIGS. 3aa, ab, and ac show a second and a third embodiment, a flat heating system according to the invention, schematically in a perspective overview representation or a section view in connection with an inner lining of a motor vehicle.

FIGS. 4aa and 4ab show schematically an inner lining coating of a motor vehicle as a fourth embodiment of a flat heating system in a perspective overview representation and a section view, respectively.

FIGS. 5aa and 5ab show schematically a fifth embodiment of an object with a flat heating system in a perspective overview representation and a section view, respectively, in the shape of a floor covering of a motor vehicle.

FIG. 6aa shows schematically as a sixth embodiment of the invention, in a perspective partial view, a motor vehicle seat with a seat heating system.

In the following description of the invention with reference to embodiments, the same reference symbols are used consistently for identical or equivalent parts. Even if all of the details of the graphical representations are not discussed in the following description, the individual features and their relationships emerge from the figures themselves, as long as they are illustrated in the figures, for someone skilled in the art without additional description.

As a first embodiment of a flat heating system 1, in FIGS. 1aa and 1ab in a section and perspective schematic view, respectively, a motor vehicle seat 2 is shown, in whose sitting surface 3 a seat heating system 4 is integrated.

The construction of the sitting surface 3 near the flat heating system 1 is shown in FIG. 1aa, in which a cross-sectional cut through the corresponding layers/components of the sitting surface 3 is shown. The surface of the sitting surface 3 is formed by a seat cover 5, which can be composed of synthetic material, artificial leather, or real leather- or some other suitable materials or combinations of these materials. The shape of the sitting surface 3 is formed at least essentially by an elastic foamed material molded body 6. The components of the seat heating surface 4 are arranged between the elastic foamed material molded body 6 and the seat cover 5.

The seat heating system 4 is formed by the flat heating system 1, which contains a heating layer 7 and a carrier 8. The carrier 8 is a flexible layer made from a fibrous nonwoven fabric with natural and/or synthetic fibers. The heating layer 7 is composed of a flexible, electrically conductive plastic foam, for example, electrically conductive polyurethane, from which a film or a foil is formed, so that a surface skin is produced. The film has no visible pores, but can also have a closed-cell or porous microstructure. In particular, the material is UV-resistant and/or hydrolyzable or vapor-permeable, in order to find use in a sitting or sleeping cushion according to the most preferred application. In this way, an optimum air-conditioning effect is guaranteed for the user by the base.

The material for forming the film, e.g., UV-resistant and hydrolyzable or vapor-permeable, cross-linked single-component polyurethane, is applied to the fibrous nonwoven fabric, for example, through spraying, so that a so-called spray flush or a spray skin is formed by this so-called spray flush method. Alternatively, the film may also be formed on the seat cover 5 or the elastic foamed material molded body 6 through this method. The material may also be sprayed into the foam mold for the elastic foamed material molded body 6 before the foamed material is introduced, in order to bond with the latter during its curing. For a production of the film through spraying, e.g., through the spraying period, the thickness of the film can be set very precisely and can be varied over its course, if necessary. Alternatively, the film can also be produced separately through rolling or coating the corresponding material, in particular, onto the carrier 7 and then, if necessary, bonding with the carrier 7, the seat cover 5, or the elastic foamed material molded body 6.

Between the heating layer 7 and the carrier 8, contact ends 9 and 10 of power supply wires 11 and 12, respectively, are placed on the edge of the heating layer 7, so that they are in electrically conductive contact with the heating layer 7 (see also FIG. 1ab).

For producing the flat heating system 1 of the first embodiment, still flowing or fluid electrically conductive polyurethane material, which contains, for example, carbon particles, as already explained farther above, are deposited through rolling, coating, or spraying on the fibrous nonwoven fabric of the carrier 8, after which the contact ends 9 and 10 of the power supply wires 11 and 12, respectively, are placed on the fibrous nonwoven fabric of the carrier 8. After the electrically conductive polyurethane foam cures, this is flexible and in electrically conductive contact with the contact ends 9 and 10 of the power supply wires 11 and 12, respectively, and forms the heating layer 7. The contact ends 9 and 10 of the power supply wires 11 and 12, respectively, can be fixed just through the bonding forces between the polyurethane foam and the fibrous nonwoven fabric. For further securing the attachment, the contact ends 9 and 10 of the power supply wires 11 and 12, respectively, can also be stitched to the composite (not shown). In this variant, the electrically conductive PU layer of the heating layer 7 simultaneously also represents an adhesive or bonding layer.

Instead of forming the heating layer 7 directly on the fibrous nonwoven fabric of the carrier 8, the heating layer 7 can also be formed separately and joined in a cured but flexible state to the carrier 8. The attachment between the heating layer 7 and the carrier 8 is realized, for example, through adhesion, stitching, or welding, according to which processing can he performed in connection with the materials being used. The contact ends 9 and 10 of the power supply wires 11 and 12, respectively, do not absolutely have to lie between the carrier 8 and the heating layer 7, but instead can also be joined to the heating layer on the side of the heating layer 7 facing away from the carrier 8, in order to obtain an electrically conductive contact.

The fibrous nonwoven fabric of the carrier 8 can also be a strip material at first, on which the heating layer 7 is formed over the entire surface or shaped according to the geometry necessary for the sitting surface 3 or the prefabricated heating layer 7, also as a strip material or as parts shaped according to the geometry required for the sitting surface 3, is placed on this surface and bonded to it. Then the desired individual parts can be produced according to the geometry required for the sitting surface 3, for example, through stamping. However, it is also possible to produce the fibrous nonwoven fabric first in the geometry necessary for the sitting surface 3 and to form the heating layer 7 on top of this surface, wherein this layer can also be prefabricated according to the geometry required for the sitting surface 3. The contact ends 9 and 10 of the power supply wires 11 and 12, respectively, can be laid in-between during the production of the composite made from the carrier 8 and the heating layer 7 accordingly, or can be arranged on the joined composite for suitable attachment.

In FIG. 1ab, in a schematic perspective view, the first embodiment of the flat heating system 1 is shown while leaving out the seat cover 5. Here, the profile of the contact ends 9 and 10 of the power supply wires 11 and 12, respectively, can be easily seen. Furthermore, a power controller 13 and a power source 14 for controlling or operating the flat heating system 1 is shown schematically. The power controller 13 can be activated manually and/or electrically/electronically and/or automatically. In practice, the power controller 13 involves the typical control of the temperature in the vehicle interior or a part of this interior or it involves a special control. The power supply wires 11 and 12 are connected to the power controller 13 and end virtually at their contact ends 9 and 10, respectively. Before the contact ends 9 and 10 there can also be, for example, another functional unit 15 on the power supply wires 11 and 12, which can include, e.g., a separate seat occupancy sensor, a heat sensor or temperature sensor, a distributor, and many others.

The carrier 8 may also be formed instead from a fibrous nonwoven fabric through other materials and structures, for example, a woven fabric. However, the carrier 8 may also be a molded part, for example, the elastic foamed material molded body 6 of the first embodiment according to FIGS. 1aa and 1ab.

Suitable materials for the heating layer, i.e., the electrically conductive foamed material, are specified in the present document, in particular, with reference to their physical properties and are, incidentally, well known to the technical world and, for example, also given in the state of the art cited in the present document, so that a more detailed discussion is not needed, but instead all of the suitable materials, especially from the older publications cited or given in the present document, are incorporated herein through this reference.

Although not explained above and also not shown in FIG. 1ab, the backrest 16 only partially visible in FIG. 1ab can also be equipped with a flat heating system 1. Furthermore, without limiting all of the similar objects, in particular, mattresses or other cushions, can be equipped with a flat heating system 1 according to the invention. Furthermore, an application of the invention for side linings and floor coverings especially in motor vehicles is preferred.

FIGS. 2aa and 2ab show representations analogous to FIGS. 1aa and 1ab, respectively, merely for illustrating the differences in the present invention to the state of the art. This previously known flat heating system 1 in the form of a seat heating system 4 for a motor vehicle seat 2 typically has the seat cover 5 and an elastic foamed material molded body 6, between which there is the flat heating system 1.

In the state of the art, the flat heating system 1, as shown in FIG. 2aa, viewed from the seat cover 5, contains the series of a top woven fabric layer 17, a top foamed material layer 18, a heating wire layer 19, a bottom foamed material layer 20, and a bottom woven fabric layer 21, which are bonded as a prefabricated composite by means of a two-sided adhesive bonding tape 22 to the foamed material molded body 6 forming the actual seat cushion at least in a slip-proof way.

In the production of this flat heating system according to the state of the art, the woven fabric layers 17 and 21 are first bonded to the directly adjacent foamed material layers 18 and 20, respectively, in a flame plating method.

In FIGS. 3aa, 3ab, and 3ac, 4aa and 4ab, as well as 5aa and 5ab, additional embodiments of heating devices in motor vehicles are shown.

In FIG. 3aa, a motor vehicle K is shown in a cut-away drawing, in which a section plane A through an inner lining 23 of a vehicle door 24 is shown schematically. The schematic section view of the inner lining 23 in the section plane A according to the arrows shown in FIG. 3aa is shown as a second embodiment of a heatable object with a flat heating system 2 in FIG. 3ab. This inner lining 23 contains as a carrier 8 a carrier layer 24, on which the heating layer 7 with electrically conductive plastic is applied by means of adhesive 25. Because the visible surface of the inner lining 23 is formed by the heating layer 7 with electrically conductive plastic, the free, visible side 26 of the heating layer 7 with electrically conductive plastic can be provided with decoration (not visible), e.g., an artificial leather-like appearance, in order to achieve a pleasant exterior for the inner lining 23.

As an alternative to the previously described embodiment, in one variant shown in FIG. 3ac in a section view, the heating layer 7 with electrically conductive plastic can be applied by means of adhesive 25 onto the side of the carrier layer 24 facing away from the interior space 26 of the motor vehicle K. In such a case, either the carrier layer 24 itself can be provided with decoration (not visible) on its visible side, or decoration 27 (which is only partially indicated for better clarity) can be applied on the visible side of the carrier layer 24.

The principle of the two embodiments just described can be transferred to the entire passenger compartment 26 of the motor vehicle K, especially to the extent that the corresponding parts are upholstered. For example, vehicle seats can be used as heatable objects with heating devices containing a heating layer 7 with electrically conductive plastic for realizing or assisting a seat heating system, a shaped ceiling lining, a rear-seat shelf, column linings, consoles, a steering wheel, carpet material, air ducts, in particular for preferably preheating cold air, among many other things, for improving the air conditioning in a motor vehicle. Therefore, it is not only possible to design the conventional heating system smaller, but also a faster and more uniformly distributed or targeted heating of the entire interior 26 of a motor vehicle K can also be achieved. Additional actual embodiments are illustrated in FIGS. 4aa and 4ab, as well as 5aa and 5ab.

FIG. 4aa shows, in a perspective view of a dashboard 28 and a console 29, the position of a section plane B, wherein the direction of view on the section plane according to the representation in FIG. 4ab is illustrated by arrows. FIG. 4ab is the section view through the dashboard 28 in the section plane B, wherein a part of an adjacent windshield 30 of the correspondingly equipped motor vehicle K is shown in section. The heating layer 7 with electrically conductive plastic forms the plastic skin, with which the dashboard 28 is coated and which forms the surface of the latter. By means of an adhesive 25, which is formed in the present fourth embodiment by a filler, such as a foamed material, etc., the heating layer 7 with electrically conductive plastic is connected to a carrier layer 24 like carrier 8 used as a holder 31. The heating layer 7 with electrically conductive plastic here forms a molded skin with embedded conductive material. Alternatively, in this embodiment, somewhat analogous to the variant shown in FIG. 3ac, the heating layer 7 with electrically conductive plastic may also be coated with a decorative layer (not shown).

In FIG. 4ab, as another embodiment of an object with a flat heating system 1, a windshield 30 is shown partially in section. This windshield 30 is provided in the area of its periphery with a black ceramic layer 32, which can be applied, for example, through screen printing. It is further provided that in the area of the ceramic layer 32, a heating layer 7 with electrically conductive plastic is attached directly or by means of an adhesive 25, for example, a bonding agent, to the windshield 30. Through this configuration, e.g., a surrounding, additional, and/or separate heating system of the windshield 30 can be realized for preventing and removing condensation or For de-icing. In addition, such a fiat heating device 1 can be provided, in particular, in the area of the rest position of windshield wiper blades (not shown), in order to realize here an additional and/or separate heating of the windshield 30, so that damage to frozen windshield wiper blades (not shown) can be prevented when the wipers (not shown) are activated.

If the heating layer 7 with electrically conductive plastic is composed of transparent material, then a transparent area of a window, e.g., a windshield 30, can also be provided with a corresponding flat heating system 1. Therefore, condensation can also be removed or prevented on windows equipped in this way and the window can also be defrosted. The heating wires used up until now, for example, in rear windshields (not shown), could then be eliminated or made with smaller dimensions.

As another variant for interior heating of a motor vehicle K, in FIGS. 5aa and 5ab, the configuration of carpet material 33 with a flat heating system 1 is shown. In this sixth embodiment, which is shown in FIG. 5ab in a partial section view, viewed according to the arrow direction on a section plane C in the view of FIG. 5aa, the construction of such a carpet material 33 is shown. Here, the heating layer 7 with electrically conductive plastic is bonded to a bottom carrier layer 24 like carrier 8 by means of the adhesive 25.

The bristles, loops, or general fibers/threads 34, which form the top side of the carpet material 33, can be fixed either to the carrier layer 24 and can penetrate through the heating layer 7 with electrically conductive plastic, but can be applied directly only to the layer with electrically conductive plastic, or they can start from a separate position (not shown), which is bonded to the heating layer 7 with electrically conductive plastic by means of adhesive 25. In the latter case, the carrier layer 24 can also be eliminated and the carrier 8 can be formed by such a separate layer (not shown).

The scope of the present invention also includes when the heating layer 7 with electrically conductive plastic is formed directly by the carrier layer 24, or when the heating layer 7 with electrically conductive plastic is fixed to the carrier layer 24 by means of bristles, loops, fibers, or threads 34, which form the top side of the carpet material 33. Furthermore, it is possible to apply the heating layer 7 with electrically conductive plastic under the use of an adhesive 25 to the bottom side of the carrier layer 24, so that conventional carpet material 33 is further produced in a conventional way and can be provided later with the flat heating system 1. It is further possible to retrofit already existing carpet material 33 with a flat heating system 2 accordingly.

As already mentioned, it is possible by connecting the heating layer 7 with electrically conductive plastic material to a power source (not shown), in order to achieve a desired heating or warming effect for the correspondingly heated objects. Because the electrical resistance of the heating layer 7 is constant, by means of the supplied electrical power the heating temperature can be defined or regulated. Advantageously, there is the ability to use both direct current and also alternating current, in particular, without generating electromagnetic pollution. Because the heat generated in this way involves flat heat exclusively, a certain temperature and heating comfort is realized.

For the use of natural raw materials, e.g., wood fibers, sisal, material from banana trees, coconut fibers, etc., the generation of odor during humid weather, as well as bacterial contaminations, often represent large problems. As in the previously described embodiments, when inner lining parts are designed to be heatable, in combination with the pure heating effect, the prevention of such odors and bacterial contaminations can also be achieved.

Other actual examples for heatable objects with a flat heating system 1 according to the present invention include, for example, a diesel tank made from plastic, with which paraffin crystallization in diesel fuel can be prevented at low outside temperatures by maintaining a minimum temperature; an oil sump, which, when heated, can preheat the motor oil for better and more efficient operation of the engine; an entire engine compartment, which allows preheating of the engine; as well as, for example, also storage areas both in passenger cars and also trucks. Thus, flat heating systems 1 can be used advantageously in the interior and exterior area of motor vehicles.

However, the present invention is not limited to use in the field of motor vehicles. All of the embodiments and variants named above, as well as analogous applications, can also be applied to other vehicles with two wheels, such as trains, ships, and airplanes.

As already mentioned, numerous other fields of application of the present invention are also possible, e.g., for motorcycles and mopeds and the like, seats and control elements can be equipped with corresponding flat heating devices. Other possible applications exist, for example, in the household (coating plastic wallpaper, wood decks, wood floors, carpets, tiles, covers for heating and water pipes, floor heating systems), in clothing and the like (shoes, boots, ski boots, work clothing, protective clothing, gloves, electric heating and warming blankets, for example in the hospital field, heating packs), in sports and hobbies (artificial grass playing fields, tent floors, sleeping surfaces in tents), as well as in the military (among other things, for preheating vehicles for better engine start-up in the winter).

Here, as preferred plastic materials that are electrically conductive or that can be made electrically conductive, only aliphatic or aromatic polyurethanes are named, in particular.

In terms of the production of a flat heating system according to the invention or of an object with this device, it is preferred when the layer with or made from electrically conductive plastic is produced in a spraying or immersion method or through roller application. A corresponding coating is provided preferably in a method for producing a heating device or an object with this device. In this way, the invention allows, in particular, also an adaptation or selection of the coating method in terms of the geometry of the shape to be coated and/or of the quantity to be produced.

In the configurations discussed above as examples and for comparison, the layer thickness of the electrically conductive layer is preferably between approximately 0.05 mm and 0.3 mm. If the electrically conductive layer is also to fulfill a function as a visible surface, then it is preferred when the thickness is greater. In particular, the scope of the present invention also includes adapting the layer thickness as a function of the requirements or required profile for the flat heating system(s) or for the object(s), which can be easily discovered through calculations or tests. For example, a layer thickness of 1.2 mm is provided when it involves a surface layer with additional function, e.g., a vehicle inner lining.

As already indicated, especially preferred specifications for the plastic material of the heating layer 7 are that it contains or is composed of polyurethane and preferably cross-linked and/or single-component polyurethane, which is, in particular, UV-resistant and hydrolyzable or vapor-permeable.

A particular specialty of the present invention is a variant in which, in particular, a weight-dependent seat occupancy detector is realized at the same time as the seat heating with the arrangement of the flat heating system 1. Such seat occupancy detectors must be realized separately today, in order, for example, to trigger an airbag in the case of an accident only when a passenger is sitting in a corresponding seat. Through the combined realization of the flat heating system I according to the present invention with the simultaneous function of a seat occupancy detection, which also can supply weight-dependent information in order to control the mode and strength of possible triggering of the airbag accordingly, not only is construction expense, but also volume and weight is saved in or on the vehicle, that is, at positions where it is not necessary for the stability and safety of the vehicle.

The flat heating system 1 contains, in particular, a strip heating layer 7 with electrically conductive plastic, for example, shown schematically in FIG. 6aa. Incidentally, all of the features according to the construction from FIGS. 1aa and 1ab can be combined with the present embodiment and are understandable for anyone skilled in the art, so that corresponding descriptions are omitted here.

Not shown separately in the drawing, but nevertheless an essential application of the present invention, is a mattress with a flat heating system according to the invention. A mattress configured in this way has, in comparison with the state of the art, a so-called electric heating blanket with metallic resistive wires, the advantage that the operating safety is at least significantly improved. Fire cannot be started by a flat heating system according to the present invention. In the case of damage to the heating layer, which can have a strip construction, no sparks are created like with metallic wires.

Likewise, it was already explained farther above, especially in connection with the first embodiment, that the heating layer 7 is a film or a foil. Preferably, it involves a lacquer-like polyurethane layer or a polyurethane lacquer layer with the given physical properties, especially enrichment with carbon dust for achieving the electrical conductivity. It is further preferred when the invention involves a single-component polyurethane material and/or an enrichment with carbon dust for the electrical conductivity.

A preferred thickness of the heating layer 7 is approximately 0.3 mm to 0.5 mm.

Instead of the spray application of the electrically conductive plastic material onto the carrier already described above in detail, for example, a rolling method can also be used. Here, liquid, e.g., polyurethane, is deposited onto a roller and discharged onto a base, for example, the carrier or an external support layer. The distance of the roller peripheral surface from the base defines the thickness of the heating layer, After the polyurethane solidifies or cures, a lacquer film with the desired properties is obtained, in turn, wherein shaping measures on the film, including cutting, can be carried out during the roller application or thereafter, as was already explained above.

If the heating layer is produced, if necessary, on the carrier through a suitable method, then subsequently, if necessary, the heating layer itself or already together with the carrier can be joined with a carrier or, e.g., a molded body or a cover through stitching, adhesive, velcro, etc., which was already discussed farther above.

The flat heating system can be operated with direct or alternating current, wherein the response behavior is better, or operation with direct current.

Additional advantages of the flat heating system according to the invention include, in addition to the cost advantage relative to earlier systems with metallic heating wires, the uniform heating behavior and the low power consumption in comparison with, for example, conventional seat heating systems with metallic heating wires, as shown in a corresponding test series.

A commercially available seat heating system made by Bauerhin (model S4300) was compared with a flat heating system according to the invention with a heating mat made from electrically conductive plastic. The sitting surface and backrest of the seat were each controllable separately. The heating mat was hooked to the top of the seat by means of head rest sockets and attached at the edge by adhesive strips.

The measurements should give information on the heating behavior and the power consumption of the two seat heating systems. The goal of the test was actually to determine the heating times with the associated power consumption for both types. For this purpose, on both heating systems a constant voltage of 12 V was applied to the connection terminals. The consumed current intensity was measured by a current measurement device integrated into the power supply. At intervals of 1 min, the temperature and the current intensity were measured. The comparison between the two heating systems was carried out on values detected on the seat.

| Heating mat made from | | | Bauerhin S4300 heating | |
|---|---|---|---|---|
| conductive plastic | | | system | |
| Temperature | Current | Time | Temperature | Current |
| in ° C. | in A | in min | In ° C. | in A |
| 21.4 | 7.4 | 0 | 22.4 | 0.0 |
| 26.0 | 7.1 | 1 | 24.1 | 7.8 |
| 30.4 | 6.8 | 2 | 26.9 | 7.7 |
| 36.0 | 6.7 | 3 | 28.8 | 7.7 |
| 37.0 | 6.6 | 4 | 30.3 | 7.6 |
| 7.0 | 6.6 | 5 | 31.1 | 7.6 |
| 39.1 | 6.5 | 6 | 31.3 | 7.6 |
| 40.3 | 6.5 | 7 | 32.5 | 7.6 |
| 41.4 | 6.5 | 8 | 33.0 | 7.6 |
| 42.1 | 6.5 | 9 | 34.0 | 7.6 |
| 42.6 | 6.5 | 10 | 34.4 | 7.9 |
| 43.1 | 6.5 | 11 | 34.7 | 7.6 |
| 43.7 | 6.5 | 12 | 35.0 | 7.7 |
| 44.4 | 6.5 | 13 | 35.4 | 8.0 |
| 44.7 | 6.5 | 14 | 35.8 | 8.0 |
| 45.1 | 6.5 | 15 | 35.6 | 7.6 |
| 46.0 | 6.4 | 25 | 36.0 | 7.6 |
| 48.1 | 6.6 | 50 | 36.1 | 7.7 |

The temperature measurement point was approximately in the center of the sitting surface for the heating mat of the flat healing system according to the invention with a heating layer with electrically conductive plastic. In the example according to the conventional construction with metallic heating wires, the temperature measurement point was approximately 0.5 cm from a heating wire. The temperature on the heating wire itself was measured at 50° C. after 25 min. This temperature is necessary to achieve a flat heating effect. However, in practice considerable problems are associated with this construction, because, for example, the wire can glow through or the scat cover can ignite due to temperatures that are too high. These problems are solved with the flat heating system according to the invention.

Another not insignificant disadvantage in the conventional seat heating surface is the point-wise high temperature, under some circumstances, at the position of the human genital area, which can lead to fertility problems. The flat heating system according to the invention, in principle, generates no high temperatures, because it can actually dissipate the heat over the entire surface, and can also be formed to emit no or weaker energy at the corresponding positions.

Additional tests have shown that the heating behavior of sitting and back surfaces are approximately the same.

The superiority of the new flat heating system according to the invention relative to the conventional construction with metallic conductive wires is clearly shown from the test results. The flat heating system with the heating layer with electrically conductive plastic heats up more quickly and consumes less power than the conventional seat heating system.

Thus, the invention creates a flat heating system that can dissipate heat over the entire surface, which can be guaranteed in a more effective way than in the state of the art for a construction with a heating layer comprising individual strips, under some circumstances with spacing, which reversibly conforms to a pressure load of a base, e.g., a seat foam body, and which leads to no build-up of moisture or air during use.

The present invention is definitely not limited to the basis of heating upholstered objects, but the applications of the flat heating system according to the invention as a seat or mattress heating system for or in a seat, especially a vehicle seat, or a mattress, are especially preferred and advantageous, so that separate protection is justifiably directed towards these applications. The flexibility of the heating layer adds special meaning.

Below, another preferred construction of the invention is explained in more detail using the embodiment shown in FIG. 7a with reference to this drawing.

Analogous to FIGS. 1aa and ab, a part of a flat heating system 1 is shown in section, which can be used as a seat heating system 4 as in FIGS. 2aa and ab. This flat heating system 1 contains a polyester or polyamide woven fabric as a carrier 8 with, for example, a mesh size of approximately 5 mm, i.e., a meshing or screen, in which adjacent, somewhat parallel material strands have a distance of approximately 5 mm. The structure of the carrier 8 and also its material is not limited to the preceding information, but instead can be selected by those skilled in the art without additional measures according to the, in particular, mechanical requirements, i.e., also other materials or material combinations, as well as thicknesses of the material strands and other mesh sizes can be selected specific to the application.

The carrier 8 is provided through spraying, immersion, rolling, or in some other way with a layer made from electrically conductive plastic according to the present invention, also as indicated in the other documents. That is, the material strands of the polyester or polyamide fabric are completely surrounded or encased with the electrically conductive plastic, which forms the heating layer 7.

As additional special features, current-carrying silver or copper wires, which form the contact ends 9 and 10 of power supply wires 11 and 12, respectively, analogous to the first embodiment from FIGS. 1aa and 1ab, are enmeshed in the polyester or polyamide fabric, i.e., in the carrier 8, for example, at the distance of 5 to 10 cm. Because the silver or copper wires, i.e., the contact ends 9 and 10 with the electrically conductive plastic are surrounded or encased by the spraying, immersion, rolling, or applying in some other way (with) the layer made from electrically conductive plastic according to the present invention, this method ensures an optimum electrical contact between these parts. The distance of the silver or copper wires as contact ends 9 and 10 of the power supply wires 11 and 12, respectively, is not limited to the given range of values, but instead can be selected by those skilled in the art without additional measures according to, in particular, the mechanical and electrical requirements, i.e., other materials or material combinations, as well as thicknesses of the contact ends 9 and 10 and other distances can also be selected specific to the application.

Preferably, but not in a limiting way, the contact ends 9 and 10 extend, in particular, in a direction approximately 90° to the direction of travel of a motor vehicle (not shown), in the case that it involves a seat heating system 4 for the flat heating system 1. In principle, however, the contact ends 9 and 10 in the form of silver or copper wires can extend in any longitudinal or transverse direction.

An especially preferred material composition for the heating layer 7, i.e., for the electrically conductive material, is:
300 g rubber, which is used in the present case as a very Line dust for the production as a granulate,
300 g tetrahydrofuran,
165 g graphite, and
300 g of a polyurethane, as an example and advantageously 4715 Lupranol made by BASF.

This produces a total quantity of 1065 g. For other quantities, the amounts are proportioned accordingly.

Advantageous amounts for the individual components of the material composition for the heating layer 7, i.e., for the electrically conductive plastic, are:
approximately 20-35%, advantageously approximately 25-30%, particularly prelerred approximately 28% of rubber or, in particular, mechanically and/or electrically identical or similar materials,
approximately 20-35%, advantageously approximately 25-30%, particularly preferred approximately 28% tetrahydrofuran or, in particular, a mechanically and/or electrically identical or similar material,
approximately 5-25%, advantageously approximately 10-20%, particularly preferred approximately 15% graphite or, in particular, mechanically and/or electrically identical or similar material, and
approximately 20-35%, advantageously approximately 25-30%, particularly preferred approximately 28% of a polyurethane, as an example and advantageously 4715 Lupranol made by BASF, or, in particular, mechanically and/or electrically identical or similar materials.

Another possible configuration of the invention is explained below. By measuring the change in power consumption of the heating layer 7, in an especially simple and advantageous way, a seat occupancy detection can be realized. This seat occupancy detection functions both for determining whether someone is actually sitting in the seat and also for determining the weight of the passenger sitting in the seat. This aspect of the present invention is especially advantageous, on one hand, in connection with the flat heating system and, on the other hand, can also be used separately as just a seat occupancy detection with a construction and features analogous to those disclosed for the flat heating system in the entirety of the present document. Thus, this seat occupancy detection is also worthy of patent protection by itself and can optionally be a component of separate protective rights applications and protective rights.

According to this additional aspect of the present invention, this relates to a seat occupancy detection, to a seat with this detection, and also to a seat occupancy detection method. This aspect in its individual constructions is disclosed herein both for itself and also in combination with the other aspects of the invention, i.e., the heating device and the flat heating system, the method for their production, and the heatable object.

The core of the seat occupancy detection is formed by elements made from electrically conductive plastic in a seat. Advantageously, elements made from an electrically conductive plastic are housed in a seat cushion and especially also in the backrest, as well as preferably also in the headrest. Advantageously, these elements involve strips made from preferably electrically conductive PU arranged, in particular, at a right angle to the direction of travel at given intervals.

It is particularly preferred when the material of these strips or general elements contains 50-70%, especially 55-60%, advantageously approximately 58% graphite, and 30-50%, especially 40-45%, advantageously approximately 42% PU. Furthermore, it is especially preferred when these strips or general elements are flexible and especially expandable and preferably can be deformed reversibly for a long time.

These elements or, in particular, strips are part of a current loop. When the elements or, in particular, when the strips expand, their cross section changes, such that it decreases in size. A cross-sectional change leads to a resistance change such that when the cross section of the electrically conductive elements or, in particular, the strips decreases, their electrical resistance decreases when an electrical current is passing through them. The change in the electrical resistance can be detected and tile corresponding information used for seat occupancy detection. For this purpose, detection devices and processing devices according to the device are provided, which are interconnected by means of suitable signal lines.

According to one improvement, as previously explained, the cross section of the elements and, in particular, the strips made from electrically conductive plastic, e.g., polyurethane, decreases as a function of the load, i.e., the weight of a person sitting on a correspondingly equipped seat. Through the latter configuration, not only the basic state of seat occupancy, but also the weight of a person can be detected, at least to an order of magnitude.

The load-dependent cross-sectional decrease in the elements or, in particular, the strips leads to an especially load-dependent change in its electrical resistance. On one hand, by means of this change a seat occupancy can be detected and especially according to the explained improvement, the weight of a person can be detected. The corresponding resistance change is detected by a sensor or detector, whose output signal is forwarded to processing and/or control devices, which determine, as a function of the output signal of the sensor, a seat occupancy and, under some circumstances, the weight of a person and which control, in turn, as a function of these results, additional devices, for example, in a motor vehicle, e.g., airbag devices, belt tighteners, seat and/or steering wheel adjusters, etc. Just for the control of safety devices, e.g., airbags, belt tighteners, and the like, the information of seat occupancy detection is especially advantageous. Furthermore, here it is especially advantageous when the information of the seat detection is combined, for example, with seat position information, because an optimum control of the safety devices can be carried out by the appropriate combination as a function of the size and weight of a passenger. Accordingly, for example, the opening behavior of an airbag can be adapted to the conditions of the occupant or passenger.

An embodiment of a seat occupancy detection is shown schematically in FIG. 8 with reference to a motor vehicle seat equipped with this detection.

Through the previously described aspect of the present invention, a seat occupancy detection, a seat with this detection, and also a seat occupancy detection method is created in an especially simple and reliable way. Here, in particular, the expandability and flexibility of the material is advantageous, so that the corresponding elements or, in particular, strips made from electrically conductive plastic, preferably polyurethane (PU), in principle, can be adapted not only to each passenger, but also dynamically follow any change when a seat equipped in this way is used. In particular, this means that seat occupancy detection is not only realized technically, but support-force measurement devices can be created, by means of which, at any time, a compressive load in/on a seat, for example, of a motor vehicle, due to a passenger, as well as driving conditions, can be determined. Thus, at any time information on the actual sitting position and posture of a passenger, e.g., “bent forwards,” as well as loading situations due to driving, such as braking or accelerating with the result in different pressure loads, for example, on the backrest of the seat, can be determined and detected by an especially central processing and control unit (on-board computer), and can be taken into consideration for the control of other components, for example, safety devices.

For the configuration, shaping, and material composition of the seat occupancy detection, the corresponding features of the flat heating system described farther above apply without restrictions in their full extent. In this respect, all of the information is incorporated here to its full extent through this reference, in order to avoid simple repetition in connection with the seat occupancy detection.

The seat occupancy detection on one side and the flat heating system on the other side, as well as both in combination, which can be produced and realized especially advantageously through the same elements and thus extremely economically, can be produced, in particular, from material compositions disclosed in the present document. A preferred method is to add solvent to such a material composition, so that the resulting mixture can be applied through spraying, rolling, coating, or can be processed in some other way, especially onto a carrier layer or surface. In a reaction process after the application, in particular, by increasing the temperature, at a later time the solvent can evaporate. Corresponding temperatures can be applied through infrared radiation, in a heating furnace, or in some other suitable way.

As an alternative to the previously proposed fabric 7 or, in general, the layer made from electrically conductive plastic, it is possible to achieve the same effect of the heating device or flat heating system with a carbon-fiber fabric, which is to be considered as represented by all of the general information and also the previously explained embodiments shown in the drawings, as well as by the reference symbol 7. In other embodiments, the carbon-fiber fabric is to be considered as a substitute for the entire layer 1 or 6 and therefore is to be associated with these reference symbols.

In order to maintain its flexible shape, i.e., the position of the longitudinal and transverse threads relative to each other, as well as possible, the carbon-fiber fabric is provided with a flexible coating, e.g., PU. However, it is also possible and advantageous to realize the fixing of the position of the longitudinal and transverse threads relative to each other that was just described, by producing the fabric as a leno fabric. However, attention must be paid in the carbon-fiber fabric that lines (e.g., copper) for supplying power are, in particular, enmeshed or introduced in some other way at suitable intervals (according to use). The intervals of the longitudinal and transverse threads are to be selected according to use. The fixed carbon-fiber fabric described above can also be completely enclosed by a material. Then it is irrelevant whether the enclosing material is fixed or flexible.

The previously described carbon-fiber fabric, which can be, e.g., a carbon-fiber fabric coated with a polyurethane elastomer, operates, for example and preferably, in the voltage range of 3-48 VDC. Thus, temperatures of 30 to 45° can be reached without a problem. The time period for reaching a desired temperature, is controllable by means of the current intensity. At an ambient temperature of, e.g., 21° C. and constant current intensity, a significant change in the heating phase or the object temperature was no longer observed after 15 minutes in the tests. As a result, it was also obtained in this test that “set” temperatures both remain constant and also were reproducible. An individual temperature regulation of the objects was realized by the change in the supplied voltage or current intensity, optionally, with the help of temperature sensors, which take into account the ambient temperature or the object temperature and which control or regulate the voltage supply or current intensity.

To control the temperature, for any versions according to the present document, a control or regulating loop, including temperature sensor signals or measurement values can be provided, which controls the operation of the heating device or flat heating system on the basis of a comparison of desired and actual values.

Such a carbon-fiber fabric coated with a polyurethane elastomer can be produced, for example, through spraying, immersion, or rolling methods described farther above in connection with electrically conductive plastics.

By changing the cross-sectional and/or surface dimension due to loading of the carbon-fiber fabric, a change in the current intensity can be measured. This measurable change in the current intensity can be used optionally for additional functions: in motor vehicles, e.g., as seat occupancy detection or even as detection of the weight and the exact position of the driver or passenger.

The carbon-fiber fabric is preferably produced as a leno fabric or as a half-cross leno fabric according to another aspect of the present invention. In addition, it is also sufficient for the function when the carbon fiber is worked either into the warp or woof in the web process. Here, as transverse threads in the warp or woof, an arbitrary plastic thread can be used. However, it is also very important that a fixed connection between the carbon fibers and the power supply wire or the carbon fiber and the plastic fabric is guaranteed. This is achieved soonest by using a leno or half-cross leno fabric.

Thus, on one hand the present invention relates to a heating device, a flat heating system, a method for the production thereof, and a heatable object, as well as, on the other hand, a seat occupancy detection, a seat with this detection, and a seat occupancy detection method each individually and preferably in combination. A combination is especially advantageous, because the same physical devices can be used for realizing both basic aspects of the present invention.

To the extent that a seat heating system was referenced above, for the present document in particular the application of the corresponding technology, especially for mirrors and particularly preferably for exterior mirrors of motor vehicles, is to be considered essential in the scope of the invention.

The present invention was explained in more detail above with reference to embodiments, to which, however, the invention is not limited. All of the modifications, variations, and substitutes of the features explained above and reproduced in the drawings are included in the area of expert knowledge of the present invention. In particular, all of the possible configurations lying in the scope of the associated claims belong to the invention. In particular, the presented uses of the heating devices according to the invention are also disclosed and, if necessary, to be considered as worthy of separate patent protection.

1. Heating device with a layer with electrically conductive plastic, characterized in that the layer (6) with electrically conductive plastic has an adhesive characteristic at least in some sections of at least one side.

2. Heating device according to claim 1, characterized in that the layer (6) with electrically conductive plastic has an adhesive (9) at least in some sections of at least one side for providing the adhesive characteristic.

3. Heating device according to claim 2, characterized in that the layer (6) with electrically conductive plastic has an adhesive (9) at least in some sections on both sides.

4. Heating device according to claim 2, characterized in that the adhesive (9) is a bonding agent or a foamed material.

5. Heating device according to claim 4, characterized in that the layer (6) is an adhesive strip.

6. Heating device according to claim 1, characterized in that the layer (6) is an adhesive layer.

7. Heating device according to claim 6, characterized in that the adhesive layer is a bonding-agent layer.

8. Heating device according to claim 7, characterized in that the layer (6) with electrically conductive plastic and optionally the adhesive (9) is/are transparent at least essentially or in some sections.

9. Heating device according to claim 2, characterized in that the adhesive (9) can be cured.

10. Heating device according to claim 9, characterized in that the cured adhesive (9) remains at least essentially cured when the temperature increases,

11. Heating device according to claim 10, characterized in that the electrically conductive plastic contains polyurethane.

12. Method for producing a heating device, which contains a layer with electrically conductive plastic, characterized in that an adhesive (9) is applied at least on one side (7, 8) of the layer (6) with electrically conductive plastic.

13. Method according to claim 12, characterized in that an adhesive (9) is applied on both sides (7, 8) of the layer (6) with electrically conductive plastic.

14. Method according to claim 12, characterized in that the heating device (2) is produced in sheets or as a strip material.

15. Method according to claim 14, characterized in that a desired shape of the heating device (2) is cut or stamped from sheets or strip material before the heating device (2) is bonded to an object (1) by means of its adhesive (9).

16. Method according to claim 12, characterized in that the adhesive (9) is covered with a removable protective layer after application onto the layer (6) with electrically conductive plastic.

17. Method for producing a heating device, which contains a layer with electrically conductive plastic, characterized in that an adhesive (9) is mixed with an electrically conductive plastic and that the adhesive mixed with the electrically conductive plastic is applied onto a surface as layer (6).

18. Heatable object with a heating device according to claim 1, characterized in that the layer (6) with electrically conductive plastic has an adhesive characteristic at least in some sections of at least one side, by means of which the layer (6) with electrically conductive plastic is bonded with at least one component of the object (1).

19. Heatable object with a heating device according to claim 1, characterized in that the layer (6) with electrically conductive plastic has an adhesive characteristic at least in some sections on both sides and different components of the object (1) are bonded by means of the adhesive characteristic of the heating device (2).

20. Heatable object according to claim 18, characterized in that the layer (6) with electrically conductive plastic by means of the adhesive characteristic is present only in one section of the other component or the other components of the object (1).

21. Heatable object according to claim 18, characterized in that the layer (6) with electrically conductive plastic is present at least essentially over an entire surface area of the other component of the object (1).

22. Method for producing a heatable object, which contains a heating device with a layer with electrically conductive plastic, characterized in that an adhesive characteristic is produced in the layer (6) with electrically conductive plastic at least in some sections of at least one side (7, 8), and that the layer with its side (7, 8) with the adhesive characteristic is then attached to at least one other component of the object (1).

23. Method according to claim 22, characterized in that an adhesive characteristic is produced on the layer (6) with electrically conductive plastic at least in some sections on both sides (7, 8), and that the layer (6) with each of its sides (7, 8) with the adhesive characteristic is then attached to a different component of the object (1), in order to bond the two different components.

24. Method according to claim 22, characterized in that the adhesive characteristic is produced covering the entire surface area on the layer (6) with electrically conductive plastic.

25. Method according to claim 22, characterized in that the corresponding adhesive characteristic on the layer (6) with electrically conductive plastic is produced by applying adhesive (9) on the corresponding side (7, 8) of the layer (6) with electrically conductive plastic.

26. Method for producing a heatable object, which contains a heating device with a layer with electrically conductive plastic, characterized in that an adhesive (9) is first mixed with electrically conductive plastic; in that the adhesive (9) mixed with the electrically conductive plastic is then applied onto a first component of the object (1); and in that then the first component is bonded to a second component of the object (1) by means of the adhesive (9) with the mixed electrically conductive plastic.

27. Method according to claim 25, characterized in that the adhesive (9) is cured after the final contact with the corresponding other component of the object (1).

28. Heating device according to claim 1, characterized in that the layer (6) with electrically conductive plastic has a thickness of at least approximately 0.05 mm.

29. Heating device according to claim 28, characterized in that the layer (6) with electrically conductive plastic has a thickness of at most approximately 0.3 mm.

30. Heating device according to claim 28, characterized in that the layer (6) with electrically conductive plastic has a thickness greater than 0.3 mm and, in particular, approximately 1.2 mm.

31. Heatable object according to claim 18, characterized in that the layer (6) with electrically conductive plastic has a thickness of at least approximately 0.05 mm.

32. Heatable object according to claim 31, characterized in that the layer (6) with electrically conductive plastic has a thickness of at most approximately 0.3 mm.

33. Heatable object according to or claim 31, characterized in that the layer (6) with electrically conductive plastic has a thickness greater than approximately 0.3 mm and, in particular, approximately 1.2 mm.

34. Method according to claim 12, characterized in that the layer (6) with electrically conductive plastic is produced in a spraying or immersion method or through rolling application.

35. Method according to claim 22, characterized in that the layer (6) with electrically conductive plastic is produced in a spraying or immersion method or through rolling application.

36. Radiant heating system with a carrier and a heating layer, which contains electrically conductive plastic, characterized in that the heating layer (7) is formed by a flexible film and that the carrier (8) is flexible.

37. Radiant heating system according to claim 36, characterized in that the carrier (8) is a layer, especially a woven or nonwoven fabric, advantageously a natural or synthetic fibrous nonwoven fabric.

38. Radiant heating system according to claim 36, characterized in that the heating layer (7) contains polyurethane, single-component polyurethane, cross-linked single-component polyurethane, a PU foam, UV-resistant and/or hydrolyzable or vapor-permeable plastic material, and/or in that the electrically conductive plastic of the heating layer contains graphite, advantageously in powder form.

39. Radiant heating system according to claim 36, characterized in that the contact ends (9, 10) of power supply wires (11, 12) contact the heating layer in the heating layer (7) or between the carrier (8) and the heating layer (7).

40. Radiant heating system according to claim 39, characterized in that the contact ends (9, 10) of the power supply wires (11, 12) are fixed to the heating layer by means of the heating layer (7) itself.

41. Radiant heating system according to claim 39, characterized in that the contact ends (9, 10) of the power supply wires (11, 12) are stitched or adhered to the heating layer (7) and/or to the carrier (8).

42. Radiant heating system according to claim 39, characterized in that the heating layer (7) is formed directly on the carrier (8) through spraying, rolling, or coating.

43. Radiant heating system according to claim 39, characterized in that the heating layer (7) is adhered, stitched, or fused to the carrier (8).

44. Radiant heating system according to claim 39, characterized in that the carrier (8) is a molded part (6) made from an elastic material.

45. Radiant heating system according to claim 44, characterized in that the molded part (6) is a seat cushion of a sitting surface (3) or a backrest (16) or a cushion of sitting or sleeping furniture, in particular, a mattress.

46. Radiant heating system according to claim 44, characterized in that there is a power controller (13), which can be activated manually and/or electrically/electronically and/or automatically and which can be connected to a power source (14) and to which power supply wires (11, 12) are connected, whose contact ends (9, 10) contact the heating layer (7).

47. Radiant heating system according to claim 44, characterized in that the carrier (8) is formed by a fabric, which is advantageously a polyester or polyamide fabric and/or has a mesh size of approximately 5 mm.

48. Radiant heating system according to claim 47, characterized in that contact ends (9 and 10) of power supply wires (11 and 12, respectively) are worked into the fabric and advantageously have a spacing of 5 to 10 cm and/or are formed from silver or copper wires.

49. Radiant heating system according to claim 47, characterized in that the carrier (8) is provided with the heating layer (7) through spraying, immersion, rolling, or in some other way, i.e., with a layer made from electrically conductive plastic, so that advantageously the carrier (8) and/or the contact ends (9 and 10) are surrounded or encased completely with the electrically conductive plastic.

50. Radiant heating system according to claim 49, characterized in that the material composition for the heating layer (7), i.e., for the electrically conductive plastic, contains:
approximately 20-35%, advantageously approximately 25-30%, particularly preferred approximately 28% of a rubber or, in particular, mechanically and/or electrically identical or similar materials,
approximately 20-35%, advantageously approximately 25-30%, particularly preferred approximately 28% tetrahydrofuran or, in particular, mechanically and/or electrically identical or similar materials,
approximately 5-25%, advantageously approximately 10-20%, particularly preferred approximately 15% graphite or, in particular. mechanically and/or electrically identical or similar materials, and
approximately 20-35%, advantageously approximately 25-30%, particularly preferred approximately 28% of a polyurethane, as an example and advantageously 4715 Lupranol made by BASF, or, in particular, mechanically and/or electrically identical or similar materials.

51. Heatable object, characterized in that a radiant heating system (1) according to one of the preceding claims is included.

52. Heatable object according to of the claim 51, characterized in that the object is a sitting surface (3) or a backrest (16) or a cushion of sitting or sleeping furniture, in particular, a mattress, and in that advantageously the heating layer is anatomically adapted to the upper-leg sitting surfaces and/or back surfaces of a user.

53. Heatable object according to claim 51, characterized in that the heating layer (7) is shaped anatomically in the plane of sitting surface (3) or the backrest (16) or the cushion of sitting or sleeping furniture, in particular, a mattress, in that it is present or electrically conductive only according to standard anatomical profiles.

54. Heatable object according to claim 51, characterized in that the heating layer (7) has a corresponding thickness profile for anatomically adapted heat output.

55. Heatable object according to claim 54, characterized in that the object is an upholstered lining (23), especially of a motor vehicle (K).

56. Heatable object according to claim 55, characterized in that the radiant heating system (1) of the object is designed for heat output that varies over its surface area.

57. Heatable object according to claim 56, characterized in that the heating layer (7) is profiled in its surface coverage and/or in its thickness for heat output that varies over its surface area.

58. Method for producing a radiant heating system, wherein a heating layer with electrically conductive plastic is bonded to a carrier, characterized in that the heating layer (7) is formed first by applying an electrically conductive, in particular, foaming or foamed plastic material onto the carrier (8) and then curing the plastic material on the carrier (8).

59. Method according to claim 58, characterized in that before the application of the electrically conductive, in particular, foaming or foamed plastic material onto the carrier (8), contact ends (9, 10) of power supply lines (11, 12) are first arranged on the side of the carrier (8), on which the plastic material is then applied.

60. Method for producing a radiant heating system, wherein a heating layer with electrically conductive plastic is bonded to a carrier, characterized in that the heating layer (7) is produced from an electrically conductive, in particular, foaming or foamed plastic material and is then arranged on the carrier (8).

61. Method according to claim 60, characterized in that the heating layer (7) is bonded to the carrier in a slip-proof way after being arranged on the carrier (8).

62. Method according to claim 61, characterized in that the heating layer (7) is stitched, adhered, or fused to the carrier (8).

63. Method according to claim 58, characterized in that electrically conductive polyurethane is used as the plastic material.

64. Method according to claim 58, characterized in that contact ends (9, 10) of power supply lines (11, 12) are attached to the heating layer (7) and/or to the carrier (8), so that they contact the heating layer in the composite of the carrier (8) and heating layer (7).

65. Method according to claim 64, characterized in that the contact ends (9, 10) of power supply wires (11, 12) are stitched or adhered to the heating layer (7) and/or to the carrier (8).

66. Method according to claim 58, characterized in that the heating layer (7) is profiled in its surface-area shape and/or thickness during or after its production.

67. Method for producing a radiant heating system, wherein a heating layer with electrically conductive plastic is bonded to a carrier, characterized in that a fabric is produced as the carrier (8), in that contact ends (9 and 10) of power supply lines (11 and 12., respectively), are worked into the fabric simultaneously or at a later time, and in that a heating layer is applied onto the carrier (8) and the contact ends (9 and 10).

68. Heating device with an electrically conductive layer, characterized in that the layer (6; 7) contains a carbon-fiber fabric.

69. Heating device according to claim 68, characterized in that the carbon-fiber fabric is coated with plastic.

70. Heating device according to claim 68, characterized in that metallic connections are incorporated, in particular, worked into the carbon-fiber fabric.

71. Heating device according to claim 70, characterized in that the metallic connections on opposite sides of the carbon-fiber fabric extend across at least approximately the entire dimensions.

72. Radiant heating device, characterized in that a heating device according to claim 68 is included.

73. Heatable object, characterized in that or a radiant heating device according to claim 72 is included.

74. Method for producing a heating device, characterized in that a carbon-fiber fabric is produced and provided with electrical connections.

75. Method for producing a heating device according to claim 74, characterized in that the carbon-fiber fabric is coated with plastic.

76. Method for producing a radiant heating system or a heatable object, characterized in that a heating device according to claim 75 is produced.
